(19) United States
(12) Patent Application Publication
(10) Pub. No.: US 2012/0003132 A1
(43) Pub. Date: Jan. 5, 2012

(54) Process for catalytic deoxygenation of coal mine methane

(76) Inventors: Shudong Wang, Liaoning (CN); Sheng Wang, Liaoning (CN); Zhongshan Yuan, Liaoning (CN); Chunxi Zhang, Liaoning (CN); Changjun Ni, Liaoning (CN); Deyi Li, Liaoning (CN)

(21) Appl. No.: 12/737,342

(22) PCT Filed: Apr. 19, 2010
(86) PCT No.: PCT/CN2010/000528

§ 371 Date: Dec. 30, 2010

(30) Foreign Application Priority Data
Jul. 23, 2009 (CN) 200910012669.1
Nov. 17, 2009 (CN) 200910012670.4

(51) Int. Cl. B01D 53/46; B01J 29/068; B01J 21/16; B01J 23/63

(52) U.S. Cl. 423/219; 502/304; 502/73; 502/303; 502/65; 502/63

(57) ABSTRACT

Deoxygenation catalyst for coal mine methane, its preparation method and application in catalytic deoxygenation of coal mine methane in oxygen-containing environment. The catalyst comprises a first composition serving as the active content and a second composition serving as the additive. The first composition consists of one or more platinum group noble metals selecting from the group consisting of Pd, Pt, Ru, Rh and Ir. The second composition consists of one or more alkaline metals or alkaline earth metals selected from the group consisting of Na₂O, K₂O, MgO, CaO, SrO and BaO; CeO₂ and lanthanides rare earth metals such as Pr, Nd, Sm, Eu, Gd, etc.; and/or transition metals such as Y, Zr, La, etc.; and/or Al₂O₃ oxides complexes. Said catalyst can effectively eliminate the oscillatory behavior during catalytic combustion under oxyen-lean condition. When said catalyst is applied in the catalytic deoxygenation process of the present invention, 1 to 15% of oxygen in coal mine methane can be effectively removed and a percentage yield of methane which approximately equals to the theoretical percentage yield obtained under the assumption of complete conversion of methane and oxygen can be achieved.

### BACKGROUND OF THE PRESENT INVENTION

1. Field of Invention

The present invention relates to a chemical process, and more particularly to a catalyst for removing oxygen from coal mine methane (CMM) and its method of manufacture as well as the application of the catalyst in deoxygenation of coal mine methane.

2. Description of Related Arts

Coal bed methane (CBM) is a combustible gas adhered to coal seams by adsorption which primarily consists of methane at high purity. Since hazardous substances such as sulfur (H2S) in coal and toxic substances, which are also carcinogens, such as benzene, mercury, lead, and etc., are commonly found in natural gas but are not found in coal bed methane, coal bed methane is recognized and referred to as one of the cleanest energy source in the world.

There are two conventional methods to obtain coal bed methane from coal seams, which are direct drilling from the ground surface and underground drainage. The extracted coal bed methane obtained through different methods is different significantly in terms of quality and utilization or application. In the extracted coal bed methane obtained through direct drilling, the concentration of methane is greater than 90%, hence making it possible and desirable to connecting to the natural gas piping system directly for immediate and direct utilization. The methane extracted through direct drilling can be used as a fuel for different applications, including generating electricity, industrial and domestic utilization, powering automobile, and as raw material in chemical engineering. On the other hand, in the extracted coal bed methane obtained through underground drainage, the methane has an average concentration between 30-50% and a relatively lower pressure, which is only desirable for domestic utilization in proximity areas. In addition, much of the methane obtained through underground drainage is burnt and lost, which causes a substantive waste of this useful and valuable energy source. In view of the energy crisis and the increasing demand of natural gas, this type of coal mine methane of medium to low concentration has a need to be further processed to increase the concentration and purity of methane and the pressure to facilitate utilization and transport through long distance.

The technology for purification of methane involves separation of nitrogen gas N2 or air with CH4 such that the concentration of methane in coal mine methane is increased, hence increasing the heat value and lowering the transportation cost of coal mine methane. Cryogenic separation, pressure swing adsorption and membrane separation are the three common methods used for purification. Chinese patent publication number CN1952569A and CN1908559A disclose a two-stage distillation, liquefaction method for air-containing natural gas in which liquefaction and separation are operated under low temperature, and the purity of the liquefied natural gas product is 99% or above. However, in the process of separation, when the concentration of methane is increased, the oxygen content in the exhausted gas is also increased to a level at which the methane is burnt and exploded, therefore imposing a potential safety hazard.

A method for purification and separation of methane, which is comparatively safe, is to selectively removing the oxygen content in coal mine methane through catalytic combustion. The oxygen content in coal mine methane can be lowered to 0.5% or below such that the safety hazard is eliminated. Conventional methods of deoxygenation mainly includes catalytic combustion (Chinese patent number ZL02113628.9, Chinese patent publication number CN101139239A, etc.) and coke combustion (Chinese patent number ZL02113627.0, Chinese patent publication number CN1919986A, etc.). Although coke combustion can effectively remove oxygen in coal mine methane, the use of coke as a fuel for burning involves a high energy consumption and the process of coke addition and removal are complicated (When coal is used instead of coke, the problem of SO2 emission is induced.). In addition, the high temperature environment leads to strict requirements for the equipment and lower yield of CH4 in coal mine methane due to decomposition and recombination of CH4 under high temperature. The above has resulted in increased cost for deoxygenation of coal mine methane.

Catalytic combustion involves the catalytic combustion of CH4 under lean oxygen environment in which the reaction is: CH4+2O2→CO2+2H2O. As illustrated, if 10% of O2 is to be removed, 5% of CH4 is required to be consumed, thereby the bed temperature of catalyst may reach 1000° C. or above (adiabatic temperature is increased by approximately 700° C.). Accordingly, the use of recycle reactor and partial product recycling method are preferred. As a result, the bed temperature is controlled to maintain at 650° C. or below such that the materials requirements of reactor is lessened and more flexible and the life of catalyst is prolonged, while any unwanted reaction arising from the high reaction temperature is eliminated (Thermodynamics analysis has shown that the possibility of steam reforming reaction and pyrolysis reaction of methane is lowered when the temperature is 650° C. or below.) Chinese patent publication number CN101139239A discloses a catalytic and sulfur-resistance deoxygenation method for methane-rich gas in which a portion of the deoxygenated and cooled gas is circulated to lower the concentration of oxygen so as to control the reaction temperature. However, this method makes use of sulfur-resisting manganese catalyst for deoxygenation. In order to maintain the activity level of the catalyst for deoxygenation, a relatively high temperature and low space velocity are required. While high temperature will increase the possibility of unwanted reactions for CH4 and decrease the yield of CH4, low space velocity will require a reactor of larger dimension and increase the cost of deoxygenation. In addition, the use of non-noble metals catalyst has the problem of ignition and initiation difficulties, and granular catalyst will increase the pressure drop in the catalyst bed which is undesirable for converting coal mine methane under low pressure into the reactor for catalytic deoxygenation. Accordingly, there is a need for a type of catalyst which has a low ignition temperature and can be operated steadily for a long time under a fuel-rich and oxygen-lean environment, which is of vital importance to the deoxygenation process.

Catalytic combustion of CH4 usually refers to a process involving flameless combustion at low ignition temperature (200-350° C.) which converts CH4 into CO2 and H2O by oxidation with the use of catalyst under an oxygen-rich condition (fuel/air molar ratio can be as low as 1-5%). Compared to metal oxide catalysts, loading noble metal catalysts are widely used in the catalytic combustion of CH4 because of higher activity, lower ignition temperature and better poison resistance characteristic. In view of oxidation of CH4, the noble metal Palladium (Pd) has an activity which is higher than Platinum (Pt) and Rhodium (Rh), and is commonly supported by using Al2O3, SiO2, TiO2 and ZrO2 etc. However, the Pd catalyst has one undesirable phenomenon in which the Pd catalyst is easily converted to PdO under an oxygen-rich condition, which is then reversed to Pd when the temperature is increased. The temperature at which the reduction of PdO is occurred, which is illustrated as PdO→Pd, is highly affected by the composition of natural gas and catalyst, and is about 700-800° C. in general. The equilibrium and reversible structural transformation between PdO and Pd, under some circumstances, will lead to unstable catalytic combustion which causes oscillatory behavior. In other words, when the temperature increases, the activity level increases to a certain level and then decreases suddenly. The solutions to lessen the degree of oscillatory behavior include the use of composite catalysts which consist of different metals such as Pd—Pt (K. Persson et al., J. Catal., 231(2005) 139) and Pd—Pt—Ni (JP61033233), the addition of rare earth elements such as Ce, La, Nd, Sm, etc. into Pd catalyst (U.S. Pat. No. 5,216,875), and the use of multi-layered Pd/PdO catalyst which involves special preparation method to delay the conversion, which is PdO 4 Pd (JP63088041). However, the above solutions are unsatisfactory in that the activity of the catalyst is lowered in some way.

In view of catalytic combustion of CH4 under a fuel-rich and oxygen-lean condition which is the environmental condition for operating the catalyst of the present invention, the oscillatory behavior not only occurs, but also occurs more vigorously and frequently. It is because when the oxygen level decreases during the process, the temperature at which the reversed reaction of PdO→Pd is started will be decreased. Also, in view of the overall condition favoring the occurrence of the reversed reaction, PdO is converted to Pd at a faster rate for a shorter period of time under a lowered temperature condition, thereby decreasing the activity level of the catalyst. In extreme case, the bed temperature may be decreased to a level which is lowered than the ignition temperature, causing the reaction to stop or the combustion to extinguish. Accordingly, the use of catalytic combustion of coal mine methane for deoxygenation is very difficult to realize under this particular condition.

As a result, a loading noble metal Pd catalyst which is developed for operation under the oxygen-rich condition is not a choice when the need of catalytic combustion of CH4 under a fuel-rich and oxygen-lean condition, which is the condition for operation of the catalyst of the present invention, is required. There is a need to develop a specific type of loading noble metal catalyst which is workable under a fuel-rich and oxygen-lean condition in a reducing environment.

### SUMMARY OF THE PRESENT INVENTION

The invention is advantageous in that it provides a catalyst for removing oxygen from coal mine methane (CMM) and its method of preparation as well as the application of the catalyst in deoxygenation of coal bed methane in oxygen-containing coal seams which solves the problem of oxygen related safety issues during liquefaction, transportation and storage and is suitable for use in the process of catalytic deoxygenation of coal mine methane and other oxygen-containing gas.

Additional advantages and features of the invention will become apparent from the description which follows, and may be realized by means of the instrumentalities and combinations particular point out in the appended claims.

According to the present invention, the foregoing and other objects and advantages are attained by a catalyst for deoxygenation of coal mine methane, comprising a first composition constituting an active component thereof, a second composition constituting an additive component thereof and a carrier, wherein the first composition and the second composition are loaded onto the carrier through coating to form the catalyst.

According to the catalyst of the present invention, the first composition consists of one or more platinum group noble metals selected from Pd, Pt, Ru, Rh and Ir. Preferably, the first composition is selected from one of the followings: Pd, Pd—Rh, Pd—Pt or Pd—Rh—Pt. The first composition has a percentage weight of 0.01-5% (preferably 0.1-1%) noble metals based on the total weight of the catalyst. The noble metals has a percentage weight of 50-100% (preferably 70-90%) Pd based on the total weight of the noble metals.

According to the catalyst of the present invention, the second composition consisting of one or more alkaline metals or alkaline earth metals, and CeO2-based composite oxide, wherein a percentage weight of the alkaline metals or alkaline earth metals is 1-10% (preferably 2-5%) based on the total weight of the catalyst, wherein a percentage weight of the CeO2-based composite oxide is 1-70% (preferably 5-30%) based on the total weight of the catalyst, wherein a percentage weight of CeO2 is 30-100% (preferably 40-75%) based on the total weight of the CeO2-based composite oxide. The alkaline metals or alkaline earth metals includes one or more of the followings: Na2O, K2O, MgO, CaO, SrO and BaO, preferably MgO, K2O and CaO. the CeO2-based composite oxide consists of CeO2 and lanthanides rare earth metals of Pr, Nd, Sm, Eu, Gd, and/or transition metals Y, Zr, La, and/or γ-Al2O3 oxide complexes. Preferably, the CeO2-based composite oxide is Ce—Zr, Ce—Sm, Ce—Zr—Al and/or Ce—Zr—Y.

According to the catalyst of the present invention, the carrier is selected from cordierite ceramic honeycomb, mullite ceramic honeycomb, Al2O3 ceramic honeycomb, metallic honeycomb and/or foam metal carrier.

In accordance with another aspect of the invention, the present invention comprises a preparation process of catalyst for deoxygenation, which comprises the steps of: (1) preparing and loading a CeO2-based composite oxide onto the carrier which is inert and has a systematic structural construction to form a first catalyst precursor A through drying and calcination; (2) loading alkaline metals or alkaline earth metals onto the first catalyst precursor A from step (1) to form a second catalyst precursor B through drying and calcination; (3) loading platinum group noble metals onto the second catalyst precursor B from step (2) to form a third catalyst precursor C in oxidized form through drying and calcination; and (4) reducing the third catalyst precursor C to form the catalyst in final form D through a reduction process.

According to the preparation process of catalyst for deoxygenation of the present invention, the CeO2-based composite oxide is formed by two or more compounds integrated in a microcrystalline mixture having a granular diameter smaller than 500 nm.

According to the preparation process of catalyst for deoxygenation of the present invention, in step (1), the CeO2-based composite oxide is prepared by co-precipitation, homogeneous precipitation, reverse micro-emulsion, hydrothermal synthesis or deposition/precipitation, preferably by homogeneous precipitation. In particular, the step (1) includes the steps of: suspending the CeO2-based composite oxide in powder form into de-ionized water; obtaining the CeO2-based composite oxide in slurry form which has a percentage weight between 20 and 40% through high energy ball milling (preferably by wet ball milling); adjusting a pH value of the CeO2-based composite oxide slurry to 3-4 by adding nitric acid; pasting the CeO2-based composite oxide slurry to the inert carrier to obtain the catalyst precursor A by drying and calcination. Preferably, the drying and calcination of the catalyst precursor A is a rapid drying and slow calcination process, such as drying in microwave oven for 3-10 minutes and calcination with Muffle furnace in which the temperature ramp rate is set at 2.5° C. per minute, the muffle temperature set at 700° C. and the calcination time is set between 2-4 hours. The above step can be selectively repeated for adjusting a predetermine weight of the CeO2 which is loaded onto the carrier.

An exemplary illustration of preparing Ce—Zr—Al composite oxide by using Ce(NO₃)₃.H2O, Zr(NO₃)₄.9H2O and Al(NO₃)₃.9H2O comprises the steps of:

(A-1) preparing a mixture solution which contains Ce(NO₃)₃.H2O, Zr(NO₃)₄.H2O, Al(NO₃)₃.9H2O and urea;

(A-2) heating the mixture solution of step (A-1) until the urea is decomposed, further heating until boiling and stirring for a few hours, and then obtaining CeO2-based composite oxide precursor through homogeneous precipitation; and

(A-3) aging, filtering, washing, drying and calcination the CeO2-based composite oxide precursor in step (A-2) to obtain a ternary CeO2-based composite oxide in powder form. Preferably, slow drying and slow calcination are used. For example, drying at 60° C. in vacuum for at least 15 hours and calcination with Muffle furnace in which the temperature ramp rate is set at 2.5° C. per minute, the muffle temperature set at 500° C. and the calcination time is set between 2-4 hours.

According to the preparation process of catalyst for deoxygenation of the present invention, in step (2), further comprising the steps of: providing an alkaline metals or alkaline earth metals precursor in solution form which is water soluble and loading to the first catalyst precursor A through impregnation (such as impregnating the first catalyst precursor A in Mg(NO₃)2 solution for loading MgO); and drying and calcination to obtain the second catalyst precursor B. Preferably and similarly, the drying and calcination of the catalyst precursor B is a rapid drying and slow calcination process, such as speeding drying in microwave oven for 3-10 minutes and calcination with Muffle furnace in which the temperature ramp rate is set at 2.5° C. per minute, the muffle temperature set at 700° C. and the calcination time is set between 2-4 hours. The above steps can be selectively repeated for adjusting a predetermine weight of the alkaline metals or alkaline earth metals which is loaded onto the carrier.

According to the preparation process of catalyst for deoxygenation of the present invention, in step (3), further comprising the steps of: providing a platinum group noble metals precursor in solution or in solution mixture form which is water soluble and loading to the second catalyst precursor B through impregnation (such as impregnating the second catalyst precursor B using a solution of PdCl3, RhCl3 and PtCl2 mixture for loading Pd—Pt—Rh); and drying and calcination to obtain a third catalyst precursor C. Preferably and similarly, the drying and calcination of the catalyst precursor C is a rapid drying and slow calcination process, such as drying in microwave oven for 3-10 minutes and calcination with Muffle furnace in which the temperature ramp rate is set at 2.5° C. per minute, the muffle temperature set at 700° C. and the calcination time is set between 2-4 hours. The above step can be selectively repeated for adjusting a predetermine weight of the platinum group noble metals which is loaded onto the carrier.

According to the preparation process of catalyst for deoxygenation of the present invention, in step (4), the reduction process uses H2 reduction method or hydrazine hydrate reduction method. Preferably, the reduction process is carried under the condition of 10% H2-90% N2 with a temperature of 450-550° C. for 2-4 hours.

In accordance with another aspect of the invention, the present invention comprises a process of catalytic deoxygenation of coal mine methane, which is an application process of the catalyst of the present invention in deoxygenation process of oxygen-containing coal mine methane.

The catalyst of the present invention includes the following characteristics: highly stable combustion under fuel-rich condition with high activity level, durable, low ignition temperature and insignificant side effects (reforming and decomposition of CH4). It is worth mentioning that the catalyst and the deoxygenation process which utilizes the catalyst which works effectively with high level of stability under a fuel-rich conditions to provide effect and stable catalytic combustion is the key of the present invention.

According to the process of catalytic deoxygenation of coal mine methane, the catalyst of the present invention which is being used in the process is tested in the laboratory for 3000 hours. The results show that the oxygen conversion is maintained at 96% of above, which is an indication that the oscillatory behavior of the catalyst is eliminated in principle, when compare to the Pd/Al2O3 catalyst system, which is commonly used for catalytic combustion of methane under oxygen-rich condition. In other words, the catalyst of the present invention for catalytic combustion of methane has the advantageous characteristics of high level of activity, stable combustion ability and long lifetime. The present invention, through the introduction of rare earth metal components which has a certain degree of oxygen capacity into the catalyst system of the present invention, and the utilization of interaction between the rare earth metal components and the noble metals Pd for providing a self-adjustable oxidation-reduction condition at microscopic level, successfully increases the threshold temperature for the conversion of PdO→Pd while at the same time increases the rate of re-oxidation of Pd into PdO such that the ratio of PdO/Pd is stabilized, thereby minimizing the oscillatory behavior and maximizing the combustion stability. In addition, reduction of the catalyst is carried out before use not only increases the stability during combustion, but also decreases the ignition temperature significantly which provides another important advantageous feature of the present invention. The characteristics of the catalyst of the present invention explicitly indicate that the catalyst of the present invention is especially suitable to be used for catalytic combustion of methane in the process of deoxygenation and purification of coal mine methane.

In accordance with another aspect of the invention, the present invention comprises a process of catalytic combustion of CO and short-chain hydrocarbon.

The process is further described below.

Introduce a small stream of hydrogen which is preheated to 25-50° C. into a oxygen-containing coal mine methane. Then react with oxygen on the catalyst for burning and releasing energy to preheating the catalyst such that a bed temperature of the catalyst bed is increased to reach the ignition temperature of methane for catalytic combustion. When the catalytic combustion reaches a stable status, part of the processed coal mine methane is returned to mix with the raw coal mine methane to form a mixture gas which is then input into an adiabatic fix-bed reactor through the reactor inlet of the reactor, wherein the reactor is packed with the catalyst which contains the noble metals. Then methane in the mixture gas is allowed to react with oxygen onto the catalyst to produce carbon dioxide and water and to obtain a first product gas. Water content of the first product gas is then cooled and removed to obtain a final product gas. The oxygen content in the mixture gas can be adjusted and controlled through circulating a portion of the final product gas based on a preset recycle ratio to the inlet of the reactor. The parameters and requirements of the process is further described as follows:

(1-1) the coal mine methane has an oxygen content of 1%-15% by volume;

(1-2) the final product gas has an oxygen content of less than 0.2% by volume (preferably 0.1% by volume);

(1-3) the reactor has an operation pressure of 0-10 MPa and a space velocity of 1,000-80,000 hr⁻¹, and the catalyst bed has an inlet bed temperature of 250-450° C. and an outlet bed temperature of 450-650° C. when reached the stable status; preferably, the reactor has an operation pressure of 0.01-0.03 MPa and a space velocity of 30,000-50,000 hr⁻¹, and the catalyst bed has an inlet bed temperature of 285-325° C. and an outlet bed temperature of 550-650° C. when reached the stable status;

(1-4) the water content is removed through a two-level heat exchanger and cooling process such that the temperature of the final gas product is lowered to 30-50° C.; and

(1-5) a flow ratio of the final product gas circulating to the reactor to the raw coal mine methane is 0:1 to 6:1 by volume.

According to the process of catalytic deoxygenation of coal mine methane of the present invention, which employs the catalyst of the present invention, the heat exchange and cooling is carried out through at least one high temperature heat exchanger or a heat boiler and at least one low temperature heat exchanger. The high temperature heat exchanger or a heat boiler can lower the temperature of exhaust gas at the reactor outlet to 150-500° C. The low temperature heat exchanger can lower the temperature of exhaust gas of the high temperature heat exchanger or a heat boiler further to 30-50° C.

According to the process of catalytic deoxygenation of coal mine methane of the present invention, which employs the catalyst of the present invention, the flow ratio of the final product gas circulating to the reactor to the raw coal mine methane is 0:1 to 4:1 by volume. The circulation of gas may be achieved by alternative methods. For example, the final product gas which is circulated back to the reactor is first cooled through heat exchange and dehydrated and is then preheated by high temperature reaction gas at the reactor outlet before mixing with the raw coal mine methane at room temperature. Alternately, the final product gas which is circulated back to the reactor is obtained from the reactor outlet of the reactor.

According to the process of catalytic deoxygenation of coal mine methane of the present invention, which employs the catalyst of the present invention, two alternative low-temperature ignition methods can be used. The first method of low-temperature ignition is achieved by introducing a small amount of the hydrogen gas, into the preprocessed coal mine methane which contains oxygen, wherein a flow volume of the hydrogen gas to preprocessed coal mine methane is 4-10%, thereby the oxygen in the preprocessed coal mine methane and the hydrogen gas are burnt on the catalyst to release energy and preheat the catalyst, and the bed temperature of the catalyst bed is increased to reach the ignition temperature of methane for catalytic combustion which is 250-450° C. The second method of low-temperature ignition is achieved by introducing the small amount of the hydrogen gas into the preprocessed coal mine methane which contains oxygen and is preheated to 30-50° C. through a heater, wherein a flow volume of the hydrogen gas to preprocessed coal mine methane is 4-10%, thereby the oxygen in the preprocessed coal mine methane and the hydrogen gas are burnt on the catalyst to release energy and preheat the catalyst, and the bed temperature of the catalyst bed is increased to reach the ignition temperature of methane for catalytic combustion which is 250-450° C.

According to the process of catalytic deoxygenation of coal mine methane of the present invention, which employs the catalyst of the present invention, the final product gas which is circulated back to the reactor is first cooled through heat exchange and dehydated and is then preheated by high temperature reaction gas at the reactor outlet before mixing with the preprocessed coal mine methane at room temperature.

According to the process of catalytic deoxygenation of coal mine methane of the present invention, which employs the catalyst of the present invention, the ignition for catalytic deoxygenation can be realized under low temperature condition, while highly effective and stable deoxygenation process can be carried out under low pressure, high space velocity and reaction temperature of 650° C. or below so as to remove the oxygen content in coal mine methane to a such a low level at which the ratio of oxygen to coal mine methane is less than 0.2%. The highly active catalyst, high space velocity and low catalyst bed pressure drop increase the deoxygenation capacity of per volume catalyst such that the cost of catalytic deoxygenation is lowered. The low reaction temperature avoid the problems of decomposition of hydrocarbon, carbon deposition and steam reforming of CH4 under high temperature, which is prerequisite for non-noble metals catalyst system, thereby the yield of CH4 of the present invention is increased. The present invention can be particularly suitable for catalytic deoxygenation of oxygen-containing coal mine methane which has high flowrate, low pressure, and vigorous and frequent oxygen fluctuation.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is the illustration of H2-TPR (Temperature Programmed Reduction) spectra of exemplary catalysts, namely Example-1, Example-2 and Example-3 (using 10 vol % H2/90 vol % Ar gas mixture and heating rate of 10° C./min), according to a preferred embodiment of the present invention.

FIG. 2 is the curve showing the changes in catalyst bed temperature versus time of deoxygenation reaction of Example-1 (molar composition of the fuel on a dry gas basis is 50% CH4 , 2.85% O2, N2 balance; molar fraction of steam (H2O) in the fuel is 9.1%, GHSV (Gas Hourly Space Velocity) of the fuel is 40000/hr (space velocity of the dry gas)) according to the preferred embodiment of the present invention.

FIG. 3 is the curve showing the changes in catalyst bed temperature versus time of deoxygenation reaction of Example-2 (molar composition of the fuel on a dry gas basis is 50% CH4, 2.85% O2, N2 balance; molar fraction of steam (H2O) in the fuel is 9.1%, GHSV (Gas Hourly Space Velocity) of the fuel is 40000/hr (space velocity of the dry gas)) according to the preferred embodiment of the present invention.

FIG. 4 is the curve showing the changes in catalyst bed temperature versus time of deoxygenation reaction of Example-3 (molar composition of the fuel on a dry gas basis is 50% CH4, 2.85% O2, N2 balance; molar fraction of steam (H2O) in the fuel is 9.1%, GHSV (Gas Hourly Space Velocity) of the fuel is 40000/hr (space velocity of the dry gas)) according to the preferred embodiment of the present invention.

FIG. 5 is the curve showing the changes in catalyst bed temperature versus time of deoxygenation reaction of Comparison-1 (molar composition of the fuel on a dry gas basis is 50% CH4, 2.85% O2, N2 balance; molar fraction of steam (H2O) in the fuel is 9.1%, GHSV (Gas Hourly Space Velocity) of the fuel is 40000/hr (space velocity of the dry gas)) according to the preferred embodiment of the present invention.

FIG. 6 is the curve showing the changes in catalyst bed temperature versus time of deoxygenation reaction of Comparison-5 (molar composition of the fuel on a dry gas basis is 50% CH4, 2.85% O2, N2 balance; molar fraction of steam (H2O) in the fuel is 9.1%, GHSV (Gas Hourly Space Velocity) of the fuel is 40000/hr (space velocity of the dry gas)) according to the preferred embodiment of the present invention.

FIG. 7 is the curve showing the changes in catalyst bed temperature versus time of deoxygenation reaction of Comparison-8 (molar composition of the fuel on a dry gas basis is 50% CH4, 2.85% O2, N2 balance; molar fraction of steam (H2O) in the fuel is 9.1%, GHSV (Gas Hourly Space Velocity) of the fuel is 40000/hr (space velocity of the dry gas)) according to the preferred embodiment of the present invention.

FIG. 8 is the curve showing the changes in catalyst bed temperature versus time of deoxygenation reaction of Example-2-1 for 3000 hours (molar composition of the fuel on a dry gas basis is 50% CH4, 2.85% O2, N2 balance; molar fraction of steam (H2O) in the fuel is 9.1%, GHSV (Gas Hourly Space Velocity) of the fuel is 40000/hr (space velocity of the dry gas)) according to the preferred embodiment of the present invention.

FIG. 9 is the curve showing the changes in catalyst bed temperature versus time of deoxygenation reaction of Example-2-2 under high oxygen concentration condition (molar composition of the fuel on a dry gas basis is 39.15% CH4, 12.60% O2, N2 balance; GHSV (Gas Hourly Space Velocity) of the fuel is 40000/hr (space velocity of the dry gas)) according to the preferred embodiment of the present invention, wherein the present invention includes a process of catalytic deoxygenation of oxygen-containing coal mine methane, which includes the systematic and low-temperature ignition process, the technological process and the operation parameters in the present invention.

FIGS. 10 and 11 illustrate the two alternative modes of a process of catalytic deoxygenation and recycling of oxygen-containing coal mine methane according to the preferred embodiment of the present invention, in which:

FIG. 10 illustrates a part of the process of recycling coal mine methane product, where 1 is a reactor, 2 is a compressor for circulation, 3 is high-temperature heat exchanger or heat boiler, 4 is water cooled heat exchanger and 5 is a dehydrator, wherein the re-circulated coal mine methane product is the product treated by heat exchange/cooling and dehydration process in which the product is first preheated through heat exchange with high-temperature reacting gas, then mixes with fuel gas at room temperature and feeds into the reactor. According to the above process of the present invention, the fuel at room temperature can also be preheated through heat exchange with reacting gas under high-temperature before mixing with the product treated with preheat process and feeding into the reactor; and

FIG. 11 illustrates a part of the process of recycling coal mine methane product, where 1 is a reactor, 2 is a high pressure fan for circulation, 3 is high-temperature heat exchanger or heat boiler, 4 is water cooled heat exchanger and 5 is a separation device, wherein the re-circulated coal mine methane product is the product treated by deoxygenation process and is of high temperature, wherein the product is first mixed with fuel gas at room temperature and then feed into the reactor through the fan.

### DETAILED DESCRIPTION OF THE PREFERRED EMBODIMENT

The present invention is further described as follows and is subject to change without departure from the principles of the present invention.

Unless otherwise specified, the catalyst in the detailed description of the preferred embodiment of the present invention (excluding comparative examples), which is under the reaction conditions as described in the detailed description, has a conversion rate of deoxygenation of 96% or above. In addition, in order to illustrate the catalytic combustion process of the preferred embodiments of the present invention and the comparative examples, the combustion stability status is confined to temperature variation at three different levels of the catalyst bed, namely the upper, middle and lower level. In the description and claims of the present invention, the numerical range of values as provided, such as the inlet and outlet temperature, the pressure, and the composition percentage of gas mixture, are not limited to the numerical range of absolute values as provided and are subject to deviations which are reasonable to the persons skilled in the art. In the description and claims of the present invention, the numerical absolute values as provided are interpreted as examples of the present invention. The present invention includes a high level of accuracy for all numerical values. However, due to the existence of possible standard deviation in relation to quantitative measurement, a degree of deviation of numerical values is not avoidable.

In the present invention, reaction space velocity refers to the volume flowrate of raw reaction gas (on a dry gas basis) entering into the reaction system per hour divided by the volume of catalyst, which is represented by GHSV (Gas Hourly Space Velocity) with the unit hf⁻¹.

In the present invention, catalyst ignition temperature refers to the catalyst bed temperature at which the bed temperature increases suddenly and sharply such that the catalytic combustion starts and reaches a stable status under the reaction conditions of the present invention. This temperature is defined as the catalyst ignition temperature.

In the present invention, conversion rate of deoxygenation refers to the molar ratio of oxygen converted in the raw fuel gas, that is the percentage of difference in mole of oxygen between the raw fuel gas and the product relative to the mole of oxygen in the raw fuel gas and the unit is %.

In the present invention, recycle ratio refers to the ratio of volume flowrate of the product being circulated to one of the raw oxygen-containing coal mine methane, and is represented by R.

In general, the catalytic combustion of methane is carried out under an oxygen-rich environment, and loading noble metal catalyst (such as PdO/Al2O3, etc.), is commonly used for catalytic combustion of CH4 under low temperature condition. In view of PdO/Al2O3 catalyst, decomposition and conversion between PdO and Pd is unavoidable and oscillatory behavior of the catalyst activity is resulted. The nature of this oscillatory behavior in relation to catalyst activity is caused by the periodic changes of ratio of catalyst active compositions PdO/Pd. Recently, more and more documentaries demonstrated that maintaining a certain level of PdO/Pd ratio in the catalyst not only increases the activity level of methane, but also increases the stability of the combustion process (C. A. Muller et al., Catalysis Today, 47 (1999) 245.), which is probably related to oxidation and reduction reactions during catalytic combustion of methane.

Under the oxygen-rich condition, the presence of excess O2 greatly lowers the threshold of decomposition temperature of PdO to Pd, while the Pd is more easily re-oxidized to PdO. Therefore, the oscillatory behavior of the catalyst is not vigorous and frequent at low temperature under the oxygen-rich condition. In the study conducted by Y. Deng et al., in the catalytic combustion of methane under the oxygen-rich condition, the oscillatory behavior of catalyst occurs only when the O2/CH4 ratio is between 1.0 and 2.0, which is a very limited range (Y. Deng et al., Journal of Molecular Catalysis A: Chemical, 142 (1999) 51).

The operation condition of the catalyst of the present invention is under the oxygen-lean condition, which refers to the condition when the level of oxygen is very low. First, the concentration of O2 is decreased due to combustion process and then the decomposition temperature of PdO is decreased. Secondly, PdO is more readily reduced to Pd at a lowered temperature due to the overall reduction conditions favoring the feasibility of reversed reaction which will result in the loss of activity of the catalyst. In extreme cases, the catalyst bed temperature may be decreased to a level which is lowered than the ignition temperature, causing the reaction to stop or the combustion to extinguish. Accordingly, the use of catalytic combustion of coal mine methane for deoxygenation is very difficult to realize under this particular condition. Accordingly, the present invention makes use of the composition constituents of catalyst in which rare earth metals having certain level of oxygen capacity is used to replace Al2O3 and their interactions with noble metals Pd are utilized so as to realize an auto-adjustable catalyst in relation to oxidation-reduction condition at a microscopic level, thereby delaying and minimizing the occurrence of oscillatory behavior for stabilizing the catalytic combustion process.

CeO2 and Ce-based solid solution are widely researched and applied in three-way catalyst system for purifying automotive exhaust gas. The valence change of Ce between Ce³⁺ and Ce⁴⁺ provides the oxygen storage/releasing capacity of Ce such that oxygen is stored under a fuel-lean condition and is released under a fuel-rich condition to promote the oxidation of CO and HC in the exhaust gas. At the same time, CeO2 has the properties of inhibiting Al2O3 carrier from sintering and increasing the dispersion level of noble metals on the catalyst. In the process of catalytic combustion of methane, CeO2 has different contribution to the process when compared to the use of CeO2 in three-way catalyst system for purifying automotive exhaust gas. In particular, the valence change ability of Ce between Ce³⁺ and Ce⁴⁺ is utilized for increasing the conversion temperature threshold of decomposition of PdO→Pd, and for speeding up the re-oxidation of Pd from the reduction reaction. The effect of CeO2 is proved by the reaction process of catalytic combustion of methane under oxygen-rich condition (P. O. Thevenin et al., Journal of Catalysis, 215 (2003) 78.), and a small amount of CeO2 (eg. 5 wt %) is sufficient and effective for the process. However, under oxygen-lean condition in reduction feasible environment, the rate of conversion and decomposition between PdO and Pd is greatly increased and the conversion temperature is of lower level, therefore the inclusion of a small amount of CeO2 is no longer effective and sufficient to achieve the objective as mentioned above. Accordingly, in the catalyst of the present invention, all or the majority of Al2O3 is substituted by CeO2 for supporting and spreading the noble metals Pd. Furthermore, other components which includes lanthanides rare earth metals, and/or transition metal, and/or γ-Al2O3 oxide compounds are introduced to form a binary or multi-nary CeO2-based composite oxide to provide interaction relationship between metals components so that the stability and oxygen exchange capacity of CeO2 is greatly increased while the surface area is greatly increased to improve the ignition condition.

The physical properties of CeO2-based composite oxide, such as BET surface area, particle size and distribution, pore size distribution, phase status such as whether a single phase solid solution is formed, etc., all have a direct effect on the oxygen storage capacity on CeO2-based composite oxide, hence affecting the activity and stability of the catalyst. According to the preferred embodiment of the present invention, the CeO2-based composite oxide of the catalyst of the present invention is constructed and prepared to provide optimized functionality of the catalyst, e.g. high surface area ratio, high oxygen exchange ability and thermal stability, etc.

In view of thermodynamics analysis, under the reaction conditions of catalytic deoxygenation process of coal mine methane of the present invention, steam reforming reaction of methane (CH4+H2→CO+3H2) and decomposition reaction with carbon formation (CH4→C+2H2) are less likely to occur. On the contrary, in some of the examples of the present invention, alkaline or alkaline earth metals oxides serving as additive component is introduced to increase the adsorption level of water during the process and to promote reaction between carbon on the surface of the catalyst and water so as to prevent carbon deposition on the surface of the catalyst.

In some of the examples of the catalyst of the present invention, the catalyst is pretreated with reduction reaction so as to facilitate the process with optimized ignition and combustion performance. Accordingly, the PdO/Pd ratio during ignition is stabilized and optimized and the ignition process can be started below room temperature (25° C.).

In addition, in view of the environmental conditions of large volume flowrate of coal mine methane and low pressure of the source or reservoir of coal mine methane, the catalytic bed has to have lower pressure drop. Accordingly, systematic structural construction of the catalyst such as honeycomb catalyst is employed to optimize the effectiveness and efficiency of operation of the catalyst by structural construction so as to solve the problem of pressure drop.

In principle, catalytic deoxygenation of coal mine methane is a kind of catalytic combustion of CH4 under fuel-rich and oxygen-lean conditions. It is known that CH4 is a tetrahedron which is difficult to activate. Accordingly, the realization of low-temperature ignition is one of the major issues to be solved in the process of catalytic combustion of coal mine methane of the present invention. When compared to metal oxides, calcium titanate minerals (pervoskite) and hexaaluminate catalysts, loading noble metals catalyst is widely used for ignition in the process of catalytic combustion of CH4 owing to its high catalytic activity, low ignition threshold temperature and high poison tolerance.

The principle reaction (A) of catalytic deoxygenation of coal mine methane is as follows:

methane combustion reaction: CH4(g)+2O2(g)=CO2(g)+2H2O(g) (A)

The reaction A is an exothermic reaction and □H₀ is 802.32 kJ/mol. Through thermodynamics calculation, due to the fact that the O2 concentration can reach 15% in coal mine methane, adiabatic temperature is increased by 1000° C. for removing approximately 15% of O₂, thereby the catalyst bed temperature may reach 1300° C. or above. Since most of the catalysts and equipments cannot tolerate and function under this high level of catalyst bed temperature, it is another key issue of the present invention to remove the heat generated from the reaction during the process of deoxygenation. The use of recycle reactor is a better choice.

In the process of catalytic deoxygenation of coal mine methane, under a certain temperature range, the following side reactions (B)-(F) may occur:

methane oxidation reaction: CH4+0.5O2=CO+2H2 (B)

carbon monoxide combustion reaction: CO+0.5O2=CO2 (C)

hydrogen combustion reaction: H2+0.5O2=H2O (D)

methane decomposition reaction: CH4=C+2H2 (E)

methane steam reforming reaction: CH4+H2O═CO+3H2 (F)

According to the standard data of thermodynamics of the above reactions, it can be calculated to conclude that when the temperature range is 250-1450° C., complete combustion reaction of methane (A) is the dominant reaction occurred. When the temperature is lower than 650° C., combustion reactions of CO (reaction (C)) and H2 (reaction (D)) is likely to occur at a certain level while decomposition and steam reforming reactions of methane (reactions (E) and (F)) is not likely to occur. When the temperature is higher than 650° C., reactions (E) and (F) is likely to occur and the fuel-rich and oxygen-lean conditions, which are the operation conditions of the present invention, are likely to increase the feasibility of both reactions (E) and (F). Meanwhile, when the temperature increases, concentration of H₂ and CO will increase proportionally, thereby the percentage yield of CH4 is lowered. Accordingly, a low temperature reaction condition is useful to inhibit the decomposition of CH4 into carbon and steam reforming reactions, thereby the concentration of H2 and CO in the deoxygenated product of coal mine methane is decreased, the yield of CH4 is increased and the safety level is increased. The control over catalyst bed temperature to a certain low level (such as 650° C. or below) so as to inhibit the side reactions to occur is another important key issue of the process of catalytic deoxygenation of the present invention. In the catalyst of the present invention, loading noble metals catalyst is used for temperature control.

Moreover, in order to meet the requirements of large volume flowrate of oxygen-containing coal mine methane and low pressure of the source or reservoir of coal mine methane, the catalytic bed has to have lower pressure drop. When compared to conventional granular catalyst, a systematic and geometrical structural construction, such as a honeycomb structure, is the preferred catalyst supportive structure to overcome the problem of pressure drop such that deoxygenation reaction can be carried out at a higher space velocity which will increase the catalyst processing capacity of CMM per unit mass, thereby decreasing the cost of deoxygenation.

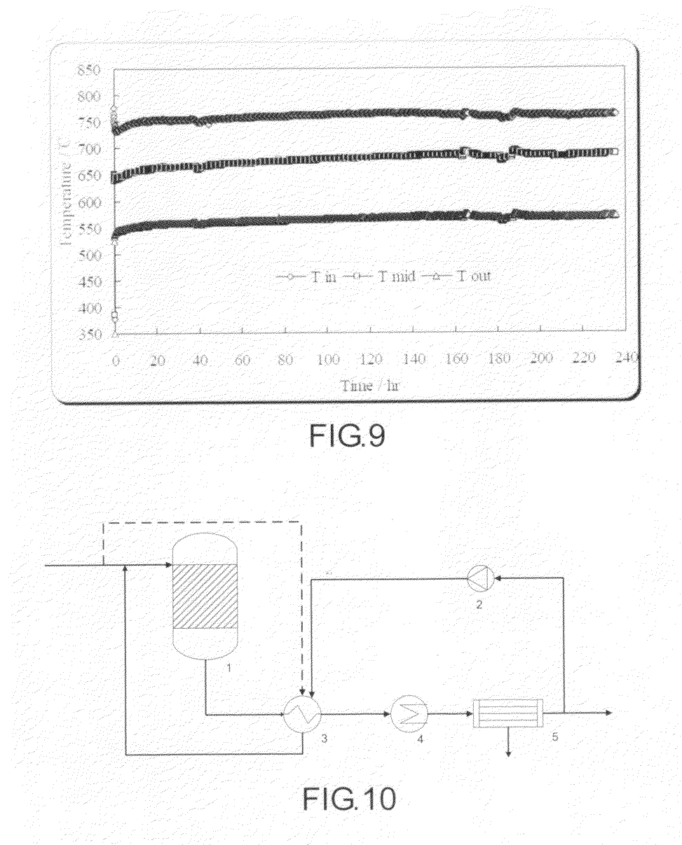

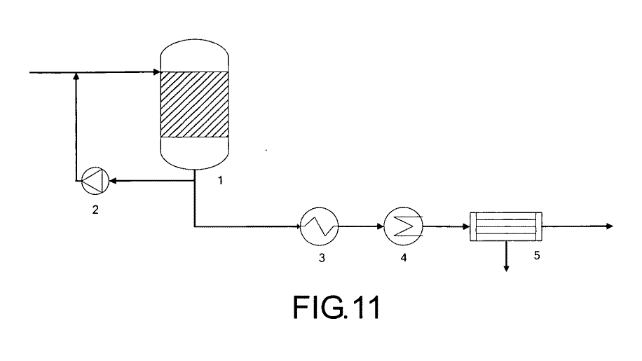

In view of the above concerns, the present invention further provides a recycle process of catalytic deoxygenation of oxygen-containing coal mine methane, which is shown in FIGS. 10 and 11 of the drawings. FIGS. 10 and 11 of the drawings are alternate illustrations of the process in which the principle elements are highlighted while other elements such as automate control system, transmission devices, valves, etc. are not illustrated. The illustrations are sufficient clear and definite for the person skilled in the art to understand and realize in relation to the subject matters of the present invention.

According to the process of catalytic deoxygenation of oxygen-containing coal mine methane of the present invention, when the operation is under a stable status, the preprocessed oxygen-containing coal mine methane (which is raw coal mine methane or coal mine methane which requires catalytic deoxygenation processing) is mixed with the final product gas obtained and delivered from the reactor through a delivery device such as a high pressure circulation fan to form a mixture gas which is then guided to flow into the reactor 1. The CH4 in the coal mine methane and O₂ then react catalytically to CO2 and H2O such that oxygen is removed through the reaction and a first product gas is produced. The first product gas is then treated with a two-leveled heat exchange/cooling process to lower the temperature of the first product gas to 30-50° C. and to remove water to form a final product gas, wherein the concentration of O2 in the final product gas is less then 0.2% by volume. The oxygen concentration of the preprocessed coal mine methane at the reactor inlet of the reactor 1 is controlled by a volume flow of the final product gas through a predetermined flow ratio of the final product gas circulating to the reactor inlet to the preprocessed coal mine methane. In the above process, the heat exchange/cooling is carried out through at least one high-temperature heat exchanger or heat boiler 3 and at least one water-cooled heat exchanger 4. The high-temperature heat exchanger or heat boiler 3 can lower the temperature at the reactor outlet to 150-500° C. The water-cooled heat exchanger 4 can further lower the temperature of exhaust gas to 30-50° C. The process of the present invention has two alternative circulation methods. In some of the examples, the final product gas being circulated back to the reactor inlet is cooled and dehydrated through heat exchange and cooling and is preheated by high temperature reaction gas at the reactor outlet before mixing with the preprocessed coal mine methane at room temperature, which is defined as low temperature circulation method. In some other examples, the final product gas being circulated back to the reactor inlet is the high temperature first product gas from the reactor before mixing with the preprocessed coal mine methane at room temperature, which is defined as high temperature circulation method. In some other examples, the final product gas being circulated is first mixed with the preprocessed coal mine methane at room temperature, which is then preheated by high temperature reaction gas at the reactor outlet before flowing into the reactor.

The present invention further comprises a specific operation procedure and operation parameters for applying in the process of catalytic deoxygenation of oxygen-containing coal mine methane according to the preferred embodiment of the present invention.

In the recycle process of catalytic deoxygenation of CMM of the present invention, the reactor is an adiabatic fix-bed reactor which is loaded with the noble metals catalyst with systematic structural construction, wherein the noble metals catalyst with systematic structural construction comprises a first composition constituting the active component which consists of one or more platinum group noble metals selected from Pd, Pt, Ru, Rh and Ir, and a carrier which is inert and has a systematic structural construction such as cordierite ceramic honeycomb, mullite ceramic honeycomb, Al2O3 ceramic honeycomb, metallic honeycomb, foam metal carrier and etc. For example, in one of the preferred noble metals catalyst with systematic structural construction, the active component is platinum group noble metal Pd, the additive component consists of one or more alkaline metals or alkaline earth metals and a binary composite oxide CeO2-La2O3, and the carrier is cordierite ceramic honeycomb. It is worth mentioning that in the process of deoxygenation of the present invention, the catalyst is not limited to the preferred noble metals catalyst with systematic structural construction in the above example. The noble metals catalyst with systematic structural construction which can provide a high activity for low temperature catalytic deoxygenation and a high level of stability under a temperature condition of 650° C. or below can also be employed in the process of deoxygenation of the present invention.

According to the process of catalytic deoxygenation of coal mine methane of the present invention, coal mine methane having a range of oxygen content between 1%-15% by volume, which is a relatively wide range of variation and is one of the characteristic of coal mine methane, can also be processed through the above process of the present invention. The reactor has an operation pressure (gauge pressure) of 0-10 MPa and a space velocity of 1,000-80,000 hr⁻¹, and the catalyst bed has an inlet bed temperature of 250-450° C. and an outlet bed temperature of 450-650° C. when the operation reaches a stable status. Accordingly, the low pressure and high space velocity operation parameters of the present invention are highly suitable for processing coal mine methane with large volume flow and low pressure head, and for heavy duty operation such that the cost is reduced. In addition, the operation temperature is below 650° C. and hence the decomposition and steam reforming reactions of CH4 are eliminated, thereby the percentage yield of CH4 is increased. Preferably, the operation pressure (gauge pressure) is 0.01-0.03 MPa, the space velocity is 30,000-50,000 hr⁻¹, the inlet bed temperature is 285-325° C. and the outlet bed temperature is 550-650° C. under the stable status.

According to the process of catalytic deoxygenation of coal mine methane of the present invention, a flow ratio of the final product gas circulating to said reactor to the preprocessed coal mine methane is 0:1 to 6:1 by volume. Preferably, the flow ratio of the final product gas circulating to the reactor to the preprocessed coal mine methane is 0:1 to 4:1 by volume, wherein the flow ratio is maintained at its lowest level for minimizing energy consumption of the fan or compressor while fulfilling the operation requirements of the catalyst for carrying out the process of the present invention.

The present invention further provides a low-temperature ignition method for the process of catalytic deoxygenation of coal mine methane of the present invention.

The low-temperature ignition method realizes the low ignition temperature feature of the process of the present invention in which the low-temperature ignition property of catalytic combustion of hydrogen and oxygen is employed. The method includes the steps of: introducing a small amount of hydrogen (H2) into the preprocessed coal mine methane which contains oxygen; allowing the oxygen in the preprocessed coal mine methane to react with the hydrogen on the catalyst to release energy and preheat the catalyst until the bed temperature of the catalyst bed is increased to reach the ignition temperature of methane for catalytic combustion to start the process of catalytic deoxygenation; and stopping the hydrogen gas supply when the catalytic reaction is steadily and the process reaches a stable status. According to some examples of the present invention, the ignition method is achieved by introducing a small amount of the hydrogen gas into the preprocessed coal mine methane which contains oxygen, wherein a flow volume of the hydrogen gas to preprocessed coal mine methane is 4-10%, thereby the oxygen in the preprocessed coal mine methane and the hydrogen gas are burnt on the catalyst to release energy and preheat the catalyst, and the bed temperature of the catalyst bed is increased to reach the ignition temperature of methane for catalytic combustion which is 250-450° C. According to some other examples of the present invention, the ignition method is achieved by introducing the small amount of the hydrogen gas into the preprocessed coal mine methane which contains oxygen and is preheated to 30-50° C. through a heater, wherein a volume flow of the hydrogen gas to preprocessed coal mine methane is 4-10%, thereby the oxygen in the preprocessed coal mine methane and the hydrogen gas are burnt on the catalyst to release energy and preheat the catalyst, and the bed temperature of the catalyst bed is increased to reach the ignition temperature of methane for catalytic combustion which is 250-450° C.

### Example 1

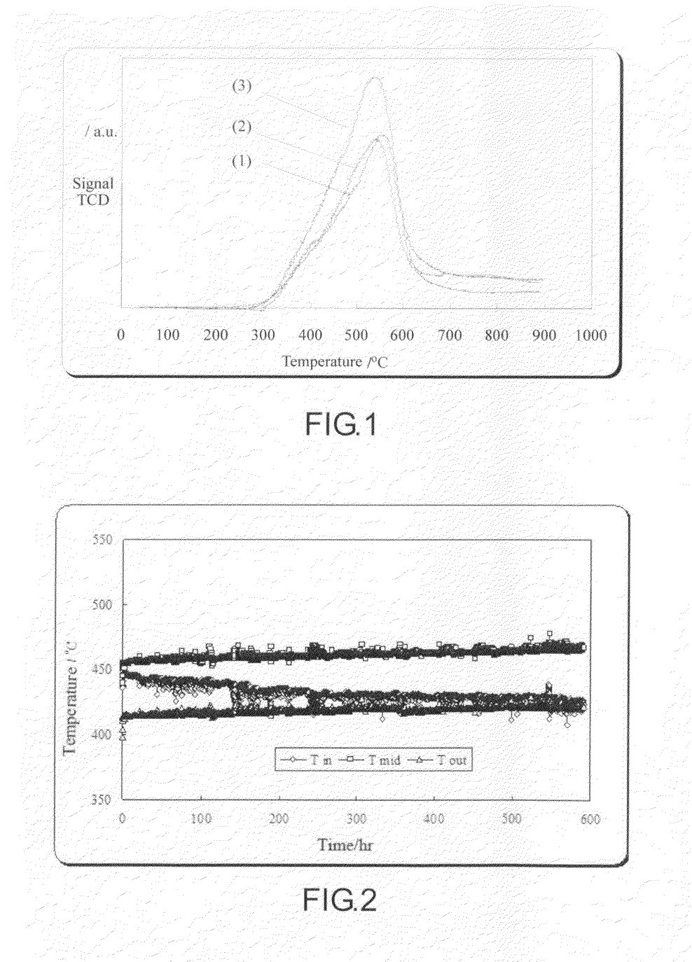

The process includes the following steps of providing and dispersing 393.574 g Zr(NO₃)₄.3H2O into 800 ml de-ionized water, heating to 75-80° C. while stirring until the Zr(NO₃)₄.3H2O is dissolved completely to form a first solution of Zr(NO₃)₄; cooling the first solution and adjusting the volume to 1000 ml to obtain a 1M Zr(NO₃)₄ solution; dissolving 100 ml of the 1M Zr(NO₃)₄ solution with 43.465 g Ce(NO₃)₃. 6H2O and 37.876 g Al(NO₃)₃.9H2O in de-ionized water and adjusting the volume to 300 ml to obtain a first intermediate solution; while stirring, adding 25-28% ammonia solution, drop by drop, to the first intermediate solution through separating funnel so as to adjust the pH of the first intermediate solution to 8-9, wherein the quantity of ammonia solution is based on the pH requirement; obtaining a first resulting precipitate and stirring for 2 hours; filtering to obtain a first filtered precipitate; washing the first filtered precipitate three times with 1200 ml de-ionized water to obtain a first washed precipitate; placing the first washed precipitate in vacuum oven and drying for 20 hours at 60° C.; calcination in Muffle furnace with temperature ramp rate of 2.5° C. per minute and muffle temperature of 500° C. for 2 hours; and obtaining a first resulting powder which is 34.314 g 50% CeO2-35% ZrO2-15% Al2O3 composite oxide in powder form. The BET surface area of the first resulting powder is 154.7 m²/g and the H2-TPR profile of the first resulting powder is shown in FIG. 1 of the drawings, wherein the H2 consumption during the reduction process is 638.5 μmol/g.

The process further comprises the followings: mix the first resulting powder with 15 ml HNO3 solution (pH 1.2) and 30 ml de-ionized water; wet ball mill for 18 hours to obtain a Ce—Zr—Al composite oxide in slurry form; adjust pH to 3-4 and percentage mass of solid content to 34% by using a predetermined amount of water and HNO₃ (pH 1.2); and finally obtain approximately 100 ml mixture slurry which can be applied for coating onto a carrier such as a honeycomb substrate.

Then, impregnate 0.3764 g cordierite honeycomb ceramic carrier in the above Ce—Zr—Al composite oxide slurry for 3 minutes and stir as appropriate during impregnation process; remove the carrier from the composite oxide slurry and blow away excess composite oxide in passages of the cordierite honeycomb ceramic carrier with compressed air; speed drying in a microwave oven for 3 minutes, calcination at 700° C. in a Muffle furnace for 2 hour; obtain a catalyst intermediate having 0.031 g Ce—Zr—Al composite oxide supported thereon. The above procedure is repeated for two times to obtain a resulting catalyst intermediate having 0.0565 g Ce—Zr—Al composite oxide supported thereon. The resulting catalyst intermediate is impregnated in 50 ml 2.7M Mg(NO3)2 solution using the same procedure as mentioned above to load 0.014 g MgO onto the resulting catalyst intermediate. Then, the same procedure is employed to load the catalyst composition of noble metals PdO onto the resulting catalyst intermediate which is loaded with MgO, wherein the immersing solution is 50 ml 7 mg/ml PdCl2 solution.

Dry with microwave and continue calcination at 700° C. in a Muffle furnace for 2 hours to yield the required noble metals honeycomb ceramic catalyst in oxidized form. The above catalyst is then reduced at 450° C. under 10% H2-90% N2 atmosphere for 2 hour to obtain the catalyst in reduced form, which is 0.18% Pd/3.13% MgO/12.62% Ce—Zr—Al—Ox/84.07% cordierite and is labeled as Example-1.

### Example 2

The process is as follows: Provide 30 L de-ionized water in a reaction device such as reaction kettle or reaction tank; add 6459 g urea and 1311 g (NH4)₂Ce(NO₃)₆ into the reaction device while stirring; add 2.39 L (1M) Zr(NO₃)₄ and 12 L de-ionized water into the reaction device; provide heating until all the urea is decomposed; while stirring, keep heating further until boiling (98-100° C.) for 4 hours; continue stirring and aging for 2 hours without heating; obtain a second resulting precipitate, which is a precursor CeO₂—ZrO₂ composite oxide, through homogenous precipitation; filter to obtain a second filter cake; wash the second filter cake two times with 60 L boiling water while stirring in the reaction device to obtain a second washed filter cake, and conduct centrifuge filtering for the second filter cake after each washing; disperse the second washed filter cake into 10 L isopropyl alcohol (propan-2-ol) to remove residual water; remove the isopropyl alcohol by centrifuge filtration to obtain a second washed precipitate; place the second washed precipitate in vacuum oven and oven dry for 20 hours at 60° C.; continue calcination in Muffle furnace with temperature ramp rate of 2.5° C. per minute and muffle temperature of 500° C. for 2 hours; and obtain a second powder of Ce—Zr binary composite oxide, which is 700 g 58% CeO₂-42% ZrO₂ in powder form. Similarly, prepare 100 g γ-Al2O3 by using 750 g Al(NO₃)₃.9H2O through the above method; then disperse 700 g second powder of Ce—Zr binary composite oxide and 100 g γ-Al2O3 in 500 ml HNO3 solution (pH 1.2) and 600 ml de-ionized water; wet ball mill for 18 hours to obtain a ternary composite oxide containing Ce—Zr oxide and γ-Al2O3, which is a microcrystalline mixture slurry; adjust pH to 3-4 and percentage mass of solid content to 34% by using a predetermined amount of water and HNO3 (pH 1.2); and finally obtain approximately 2.3 L water soluble mixture slurry which can be applied for coating onto a carrier such as a honeycomb type carrier. Though particle analysis and testing, the water soluble mixture slurry has a particle size smaller than 500 nm. Prepare a second test sample by drying and calcination a portion of the water soluble mixture slurry at 500° C. for BET and H2-TPR profiling. The BET surface area is 143.2 m²/g and the H2-TPR profile is shown in FIG. 1 of the drawings, wherein the H2 consumption is 647.6 μmol/g.

The process then continues as follows: Impregnate 790 g cordierite honeycomb ceramic carrier in the above water soluble mixture slurry for 3 minutes and stir as appropriate during impregnation process; remove the carrier from the composite oxide slurry and blow away excess composite oxide in passages of the cordierite honeycomb ceramic carrier with compressed air; speed drying in a microwave oven for 15 minutes, calcination at 700° C. in a Muffle furnace for 2 hour; obtain a catalyst intermediate having 63.2 g Ce—Zr—Al composite oxide supported thereon. The above procedure is repeated for two times to obtain a resulting catalyst intermediate having 118.5 g Ce—Zr—Al composite oxide supported thereon. The resulting catalyst intermediate is impregnated in 2 L 2.7M Mg(NO3)2 solution using the same procedure as mentioned above to load 29.1 g MgO onto the resulting catalyst intermediate. Then, the same procedure is employed to load the catalyst composition of noble metals PdO onto the resulting catalyst intermediate which is loaded with MgO, wherein the immersing solution is 2 L 7 mg/ml PdCl2 solution. Dry with microwave and continue calcination at 700° C. for 2 hours to yield the required noble metals honeycomb ceramic catalyst in oxidized form. The above catalyst is then reduced at 450° C. under 10% H2-90% N2 atmosphere for 2 hours to obtain the catalyst in reduced form. Obtain a test sample, which is labeled as Example-2, by cutting 0.4521 g of the above catalyst in reduced form randomly for analysis and testing. The result shows that Example-2 is 0.18% Pd/3.09% MgO/12.62% Ce—Zr—Al—Ox/84.11% cordierite.

### Example 3

The process is as follows: prepare a Ce—Zr composite oxide in powder form which has a composition of 58% CeO2-42% ZrO2 by using the same method of preparing Ce—Zr composite oxide in the example 2 and prepare a sample for BET and H2-TPR testing. The BET surface area is 120.4 m²/g and the H2-TPR profile is shown in FIG. 1 of the drawings, wherein the H2 consumption is 810.7 μmol/g.

The process then continues as follows: Substitute the Ce—Zr—Al ternary composite oxide or microcrystalline mixture in the example 1 and 2 with the above Ce—Zr composite oxide in powder form, employ the method in the example 1 and 2 to prepare Ce—Zr composite oxide slurry, and employ the same method as in the example 1 and 2 for coating the Ce—Zr composite oxide slurry, MgO and noble metal Pd to obtain another sample, which is 0.18% Pd/3.12% MgO/12.76% Ce—Zr—Ox/83.94% cordierite and labeled as Example-3.

### Example 4

The performance of the three catalyst samples Example-1, Example-2 and Example-3 employed in a fixed-bed reactor in the process of catalytic deoxygenation of coal mine methane are studied. According to the process of catalytic deoxygenation of coal mine methane of the present invention, the reaction conditions are set as follows: the mol percentage composition on a dry basis in the raw gas is 50% methane, 2.85% oxygen, nitrogen balance; the mol percentage of stream (H2O) in the raw gas is 9.1%; GHSV of the raw gas is 40000 (space velocity of dry basis). Raw gas with water is preheated to 300° C. and then is guided into the catalyst bed for catalytic deoxygenation combustion. In order to reduce the waste of the generating heat, the temperature of the reactor is maintained by an electric heating furnace at the outer surface thereof, wherein methane, nitrogen, carbon dioxide, carbon monoxide and hydrogen in the raw gas and product gas are detected by a thermal conductivity detector of gas chromatography; oxygen in the raw gas and product gas are on-line monitored by a PROLINE® process mass spectrograph. Data collection for the temperature of the catalyst bed is carried out at an interval of three seconds. Four thermocouples are installed at the catalyst bed for detecting the temperature of upper portion, middle portion and lower portion of the catalyst bed as well as the temperature of the main flow body respectively (which are represented by Tᵢₙ, T_{mid}, Tₒᵤₜ and T_{g} respectively). Unless particularly indicated, the performance of the catalyst in the preferred embodiments is carried out under the same experimental conditions.

During the catalytic deoxygenation process which implements the samples of Example-1, Example-2 and Example-3, oxygen concentration is maintained below 0.1% according to the on-line monitoring result from the PROLINE® process mass spectrograph. In other words, the oxygen conversion rate is maintained at 96% or above.

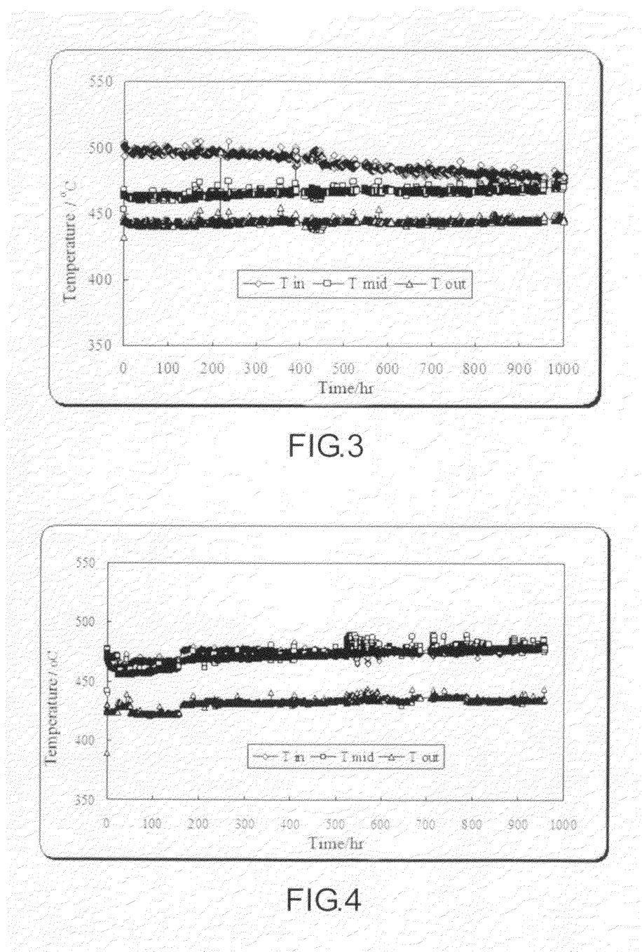

According to a gas chromatography analysis, a typical composition of product gas is 49.02% methane, 1.61% carbon dioxide, 0.2% hydrogen, 0.14% carbon monoxide, and nitrogen balance. The resulting hydrogen and carbon monoxide is come from side reactions such as incomplete oxidization of methane or steam reforming of methane, but these side reactions only amount to a small proportion. The temperature variation of the catalyst samples Example-1, Example-2 and Example-3 are shown in FIG. 2, FIG. 3 and FIG. 4 respectively. It thus can be concluded that the catalytic combustion of methane with hundreds of hours of reaction time is stable and no oscillatory behavior is observed. Referring to FIG. 2 to FIG. 4 of the drawings, the temperature of the catalyst bed is slowly decreased with the extending reaction time for the catalyst samples of Example-1 and Example-2, but the temperature of the catalyst bed for the catalyst sample of Example-3 is relatively stable, therefore, the catalytic stability of the catalyst sample of Example-3 is better than the other two catalyst samples, the high oxidization and reduction ability of CeO2-based composite oxide promoter may explain the difference (referring to H2-TPR spectra of FIG. 1).

In order to study the low temperature ignition performance of the catalyst for the catalytic deoxygenation of CMM, experiments are carried out with the fixed-bed reactor for the catalyst samples of Example-1, Example-2 and Example-3 which are prepared in Example 1, Example 2 and Example 3 respectively.

In order to provide adjustment flexibility to the fluctuation of oxygen concentration in the raw coal mine methane (a varying range of 6-12%), the ignition condition of the method for catalytic deoxygenation of coal mine methane of the present invention is set as follows: the molar composition of the dry basis in the raw gas is 50% methane, 6% oxygen; nitrogen balance. Moreover, an amount of hydrogen which constitutes 6% of the total volume flow of the above raw gas is introduced to ensure the successful ignition under room temperature (25° C.). GHSV of all gas is 50000 hr¹ on a dry basis). Unless particularly indicated, the performance of catalytic deoxygenation of coal mine methane of the catalyst in the preferred embodiments is carried out under the same experimental condition.

The success of the ignition with the catalyst is determined by whether the temperature of the catalyst bed can be increased and finally achieve a stable combustion, according to the study, the catalyst samples of Example-1 and Example-2 both can achieve a successful ignition at room temperature with GHSV of 50000 hr⁻¹ on a dry basis, but the catalyst sample of Example-3 is difficult to ignite at room temperature and has to be preheated to above 50° C. before a successful ignition can be initiated. This phenomenon can be explained as the CeO2-based composite oxide promoter of Example-1 and Example-2 have a relatively high BET surface area and thus have a better noble metal dispersion.

### Example 5

The example herein is directed to study the effect of the different composition and content of the CeO2-based composite oxide promoter on the catalytic deoxygenation and ignition performance. Mono and multiple CeO2-based composite oxide powder with different composition, γ-Al2O3 powder and ZrO2 power are prepared with the same procedure of homogeneous precipitation process in Example 2; and then the same process for preparing catalyst of Example 2 is employed to prepare a series of catalysts wherein the detailed composition of the catalysts is shown in the following Table 1. The catalysts with low percentage of CeO2 (Comparision-1 and comparision-2), and catalysts without CeO2 promoter (Comparision-1 and comparision-4) are the comparision samples.

TABLE 1
Catalyst samples with varied composition and content of CeO2-based
composite oxide promoter

| | | Composition of CeO2- |
|---|---|---|
| | | based composite oxide, |
| Sample number | Composition, wt % | wt % |
| Example-4 | 0.18% Pd/3.35% MgO/ | 100% CeO2 |
| | 13.52% CeO₂/ | |
| | 82.95% Cordierite | |
| Example-5 | 0.18% Pd/2.77% MgO/ | 66% CeO2—34% Sm2O3 |
| | 12.30% Ce—Zr—Ox/ | |
| | 84.75% Cordierite | |
| Example-6 | 0.18% Pd/3.32% MgO/ | 51% CeO2—49% La2O3 |
| | 16.55% Ce—Zr—Ox/ | |
| | 79.95% Cordierite | |
| Example-7 | 0.18% Pd/3.87% MgO/ | 85% CeO2—15% ZrO₂ |
| | 14.03% Ce—Zr—Ox/ | |
| | 81.92% Cordierite | |
| Example-8 | 0.18% Pd/3.47% MgO/ | 41% CeO2—29% |
| | 35.18% Ce—Zr—Al—Ox/ | ZrO2—30% Al2O3 |
| | 61.17% Cordierite | |
| Example-9 | 0.18% Pd/3.96% MgO/ | 58% CeO2—42% ZrO2 |
| | 56.95% Ce—Zr—Ox/ | |
| | 38.91% Cordierite | |
| Comparison-1 | 0.18% Pd/3.14% MgO/ | 29% CeO2—21% |
| | 15.58% Ce—Zr—Al—Ox/ | ZrO2—50% Al2O3 |
| | 81.10% Cordierite | |
| Comparison-2 | 0.18% Pd/2.16% MgO/ | 26% CeO2—74% ZrO2 |
| | 18.25% Ce—Zr—Ox/ | |
| | 79.41% Cordierite | |
| Comparison-3 | 0.18% Pd/3.42% MgO/ | |
| | 14.25%γ-Al2O₃/ | |
| | 82.15% Cordierite | |
| Comparison-4 | 0.18% Pd/2.96% MgO/ | |
| | 13.98% ZrO2/ | |
| | 82.97% Cordierite | |

The study of the catalytic deoxygenation performance of the above catalyst samples show that the catalyst samples from Example-4 to Example-9 having a composition within the scope of the appended claims are capable of achieving stable combustion wherein the temperature of the catalyst bed is relatively stable during the deoxygenation reactions; but a violent temperature fluctuation is observed for each of the comparison samples of Comparision-1 to Comparision-4. A typical temperature variation of sample Comparision-1 is shown in FIG. 5. Therefore, we can conclude that addition of proper amount of CeO2 plays a critical role in stabilizing the catalytic combustion under fuel rich and oxygen lean environment of the present invention.

Likewise, the low temperature ignition performances of the above catalyst samples are studied. According to the results shown in Table 2, the addition of proper amount γ-Al2O3 is beneficial for low temperature ignition of the catalysts of the present invention.

TABLE 2
Low temperature ignition performance of catalyst samples with varied
composition and content of CeO2-based composite oxide promoter

| | Ignition ability | |
|---|---|---|
| | at room temperature | Ignition temperature, |
| Sample number | (25° C.) | ° C. |
| Example-4 | No | 45 |
| Example-5 | No | 50 |
| Example-6 | No | 50 |
| Example-7 | No | 50 |
| Example-8 | Yes | 25 |
| Example-9 | No | 40 |
| Comparison-1 | Yes | 25 |
| Comparison-2 | No | 50 |
| Comparison-3 | Yes | 25 |
| Comparison-4 | No | 55 |

### Example 6

The example herein has studied the effect of the different composition and content of the noble metal catalytic active ingredient on the catalytic deoxygenation and ignition performance of the catalysts of the present invention, wherein noble metal Pd is replaced by different composition and content of mono or multiple noble metals, the preparation and composition of other ingredient of the catalysts are the same as in Example 3 (Slight differences could not be avoided because of preparing with different content of noble metal and different batches of samples). The detailed compositions of the catalysts are shown in Table 3 below, wherein catalyst samples without noble metal Pd (Comparison-5 to Comparison-7) are the comparison samples.

TABLE 3
Catalyst samples with different composition and content of noble metal
active content

| | | Noble metal content, |
|---|---|---|
| Sample number | Composition, wt % | wt % |
| Example-10 | 0.36% Pd/3.79% MgO/ | 100% Pd |
| | 13.94% Ce—Zr—Ox/ | |
| | 82.95% Cordierite | |
| Example-11 | 0.36% Pd—0.04% Rh/ | 90% Pd—10% Rh |
| | 3.77% MgO/ | |
| | 13.60% Ce—Zr—Ox/ | |
| | 82.23% Cordierite | |
| Example-12 | 0.36% Pd—0.04% | 82% Pd—9% Rh—9% Pt |
| | Rh—0.04% Pt/3.43% | |
| | MgO/11.96% | |
| | Ce—Zr—Ox/ | |
| | 84.17% Cordierite | |
| Example-13 | 0.18% Pd—0.02% | 82% Pd—9% Rh—9% Pt |
| | Rh—0.02% Pt/ | |
| | 3.82% MgO/13.65% | |
| | Ce—Zr—Ox/ | |
| | 82.31% Cordierite | |
| Comparison-5 | 0.18% Pt/3.46% MgO/ | 100% Pt |
| | 12.99% Ce—Zr—Ox/ | |
| | 83.37% Cordierite | |
| Comparison-6 | 0.18% Rh/2.86% MgO/ | 100% Rh |
| | 17.85% Ce—Zr—Ox/ | |
| | 79.11% Cordierite | |
| Comparison-7 | 0.18% Pt—0.04% Rh/ | 82% Pt—18% Rh |
| | 3.61% MgO/15.42% | |
| | Ce—Zr—Ox/80.75% | |
| | Cordierite | |

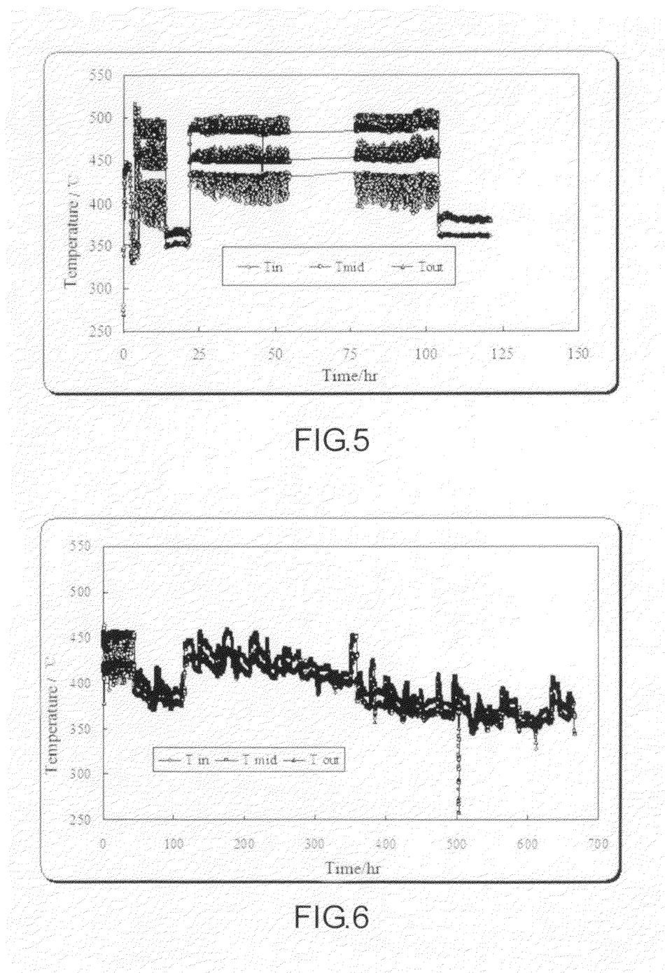

The study of the catalytic deoxygenation performance of the above catalyst samples reveal that the catalyst samples from Example-10 to Example-13 having a composition within the scope of the appended claims all achieved stable combustion wherein the temperature of the catalyst bed is relatively stable during the deoxygenation reactions; but a violent temperature fluctuation is observed for each of the comparison samples of Comparision-5, Comparision-6 and Comparision-7. The reaction temperature with the sample of Comparision-5 is evenly and gradually decreased with the extending reaction time, i.e. the catalytic combustion activity of the catalyst is gradually getting weak (As shown in FIG. 6). Therefore, we can conclude that proper amount of noble metal Pd is necessary for the stability of catalytic combustion under oxygen-lean environment of the present invention.

Likewise, the low temperature ignition performance of the above catalyst samples is studied, according to the result as shown in Table 4, appropriate increase of the amount of noble metal Pd is beneficial for low temperature ignition of the catalysts of the present invention.

TABLE 4
Low temperature ignition performance of catalyst samples with
different composition and content of noble metal catalytic active ingredient

| | Ignition ability | |
|---|---|---|
| | at room temperature | Ignition temperature, |
| Sample number | (25° C.) | ° C. |
| Example-10 | Yes | 25 |
| Example-11 | Yes | 25 |
| Example-12 | Yes | 25 |
| Example-13 | Yes | 35 |
| Comparison-5 | No | 40 |
| Comparison-6 | No | 55 |
| Comparison-7 | No | 35 |

### Example 7

The example herein has studied the effect of different reduction conditions on the catalytic deoxygenation and ignition performance of the catalysts of the present invention, wherein except the reduction conditions, the preparing and composition of other ingredient of the catalysts are the same as in Example 3 (Slight differences cannot be avoided because of preparing with different batches of samples). The detailed composition of the catalysts is shown in Table 5 below, wherein an oxidized form catalyst sample Comparison-8 is used as the comparison sample.

TABLE 5
Catalysts with different reduction conditions

| Sample number | Composition, wt % | Reduction condition |
|---|---|---|
| Example-14 | 0.18% Pd/3.55% MgO/ | Reduction at 450° C. for 4 hr |
| | 13.41% Ce—Zr—Ox/ | under 10% H2—90% N2 |
| | 82.86% Cordierite | atmosphere |
| Example-15 | 0.18% Pd/3.28% MgO/ | Reduction at room |
| | 13.12% Ce—Zr—Ox/ | temperature (25° C.) for 24 hr |
| | 83.42% Cordierite | under 3% hydrazine hydrate |
| | | atmosphere |
| Example-16 | 0.18% Pd/2.89% MgO/ | Reduction at room |
| | 12.76% Ce—Zr—Ox/ | temperature (25° C.) for 2 hr |
| | 84.17% Cordierite | under 3% hydrazine hydrate |
| | | atmosphere |
| Comparison-8 | 0.18% Pt/3.54% MgO/ | without reduction |
| | 12.76% Ce—Zr—Ox/ | |
| | 83.52% Cordierite | |

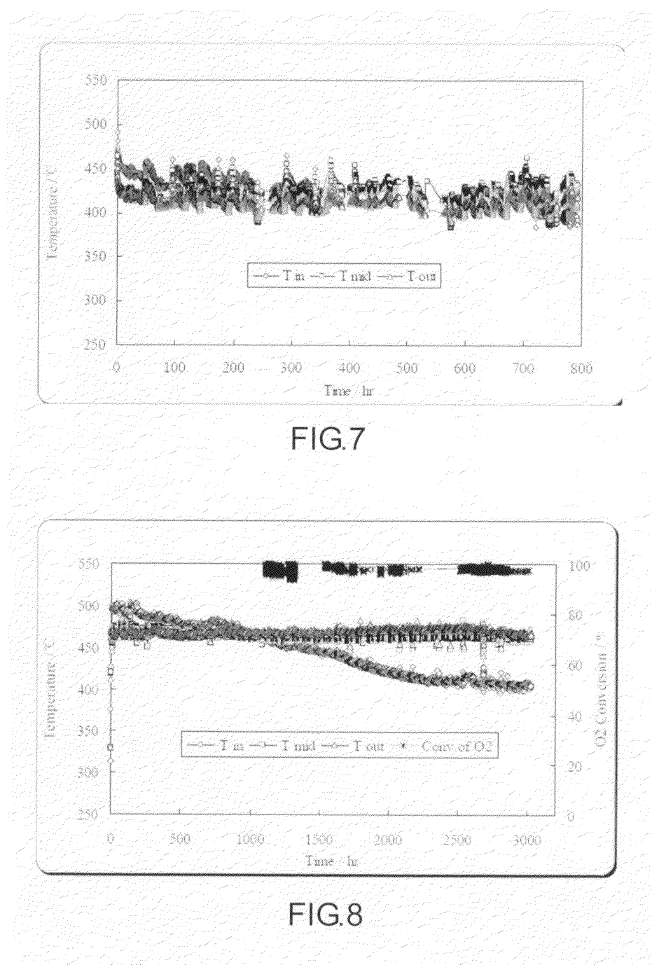

The study of the catalytic deoxygenation performance of the above catalyst samples disclose that the catalyst samples from Example-14 to Example-16 having a composition within the scope of the appended claims all achieved stable combustion wherein the temperature of the catalyst bed is relatively steady during the deoxygenation reactions; but a violent temperature fluctuation is observed for the comparison sample of Comparision-8 (As shown in FIG. 7). This phenomenon could be understood with the following explanation: for the catalyst samples which were reduced by hydrogen or hydrazine hydrate, the decomposition and conversion temperature between PdO and Pd is relatively high and the reduced Pd would be oxidized to PdO rapidly so that the combustion would be more stable.

Likewise, the low temperature ignition performance of the above catalyst samples is investigated, according to the studying result, for the low temperature ignition ability of catalysts under different reduced forms, the order listed from easy to hard would be: reduced under hydrogen atmosphere, reduced under hydrazine hydrate atmosphere for 24 hr, reduced under hydrazine hydrate atmosphere for 2 hr and just be in oxidized form without reduction.

### Example 8

The performance of the catalysts for catalytic deoxygenation under a relative long period of reaction time is investigated in this example, the experiments were carried out in a fixed bed reactor with a parallel sample Example-2-1 of the catalyst sample of Example-2 in example 2. The catalyst is ignited at room temperature (25° C.) under a initial condition wherein the molar composition is 45% methane, 6% oxygen, 6% hydrogen, nitrogen balance (dry basis); GHSV of all gas is 5000 hr⁻¹ on a dry basis, and when the combustion went into a stable stage, the initial condition is shifted to the operation condition with normal composition of raw reaction gas wherein the molar composition of the dry basis in the raw gas is 50% methane, 2.85% oxygen, nitrogen balance (dry basis); the molar fraction of the stream (H2O) in the raw gas is 9.1%; GHSV of the raw gas is 40000 hr⁻¹ on a dry basis. During a 3000 hr reaction process, oxygen concentration is maintained below 0.1% according to the on-line PROLINE® process mass spectrograph, in other words, the oxygen conversion rate is maintained above 96%. And according to a gas chromatography analysis, a typical composition of the product gas is 49.13% methane, 1.56% carbon dioxide, 0.18% hydrogen, 0.15% carbon monoxide, nitrogen balance, as shown in FIG. 8. All of the above advantages suggested that the catalysts of the present invention were suitable for catalytic combustion of methane in the aim of purification and deoxygenation of the coal mine methane.

### Example 9

The performance of the catalysts for catalytic deoxygenation under a relative high oxygen concentration (i.e. a deoxygenation process without recycle procedure) is investigated in this example, the experiments were carried out in a fixed bed reactor with a parallel sample Example-2-2 of the catalyst sample of Example-2 in example 2. The catalyst is ignited at room temperature (25° C.) under a initial condition wherein the molar composition is 45% methane, 6% oxygen, 6% oxygen hydrogen, nitrogen balance (dry basis); GHSV of all gas is 5000 hr⁻¹ on a dry basis, and when the combustion went into a stable stage, the initial condition is shifted to the operation condition with normal composition of raw reaction gas wherein the molar composition of the dry basis in the raw gas is 50% methane, 2.85% oxygen, nitrogen balance (dry basis); the molar fraction of the stream (H2O) in the raw gas is 9.1%; GHSV of the raw gas is 40000 hr⁻¹ on a dry basis). During a 240-hour reaction process, the combustion is stable, the oxygen concentration is maintained below 0.1% according to the on-line PROLINE® process mass spectrograph, in other words, and the oxygen conversion rate is maintained above 96%. The study indicated that the catalysts of the present invention may be applied to catalytic combustion with higher oxygen concentration under reduction atmosphere with rich fuel and poor oxygen and may be further employed to catalytic combustion of other combustible gas such as carbon monoxide and low carbon hydrocarbon gas.

### Example 10-Example 17

Example 10 to example 17 have investigated the effect of different recycle manner of product coal mine methane, oxygen concentration in raw coal mine methane, temperature at the inlet and outlet of the reaction bed, pressure at the inlet of the reaction bed, recycle rate R and reaction space velocity on the composition of the final product, wherein examples from example 15 to example 17 were taken as the control examples.

The catalyst used in these examples is honeycomb ceramic monolithic catalyst having a weight percentage composition of 0.2% Pd/15% CeO2-5% La203/79.8% cordierite, wherein methane, nitrogen, carbon dioxide, carbon monoxide and hydrogen in the raw gas and product gas were detected by a thermal conductivity detector of gas chromatography; oxygen in the raw gas and product gas were on-line monitored by a PROLINE® process mass spectrograph.

In the experiments, the raw coal mine methane is firstly added with an amount of hydrogen constituting 6% of the total volume flow thereof, under a condition with GHSV of all gas is 5000 hr⁻¹ (dry basis space velocity) and a temperature of 25° C. at the inlet of the reactor, hydrogen and oxygen react onto the deoxygenation catalyst to generate heat to preheat the catalyst bed so that the temperature of the catalyst bed reached the ignition temperature of the methane so that the whole deoxygenation system successfully got started, and the hydrogen supply could be cut off when the system entered into a steady operation state. The study is shown in Table 6 below wherein example 10 to example 15 employed a low temperature recycle process for the product gas whilst example 16 and example 17 employed a high temperature circulation process.

Referring to Table 6, the examples using the catalytic deoxygenation process of the present invention all achieved a good deoxygenation result in comparison with the example 15 (comparison example 15) and example 17 (comparison example 17), the oxygen content of the product coal mine methane is lower than 1000 ppm, i.e. the deoxygenation conversion rate is up to 98.5%; meanwhile, the hydrogen and carbon monoxide concentration of the product gas is relatively low, the waste of methane is minimized so that a relatively high methane yield which is appropriate to the ideal yield with a complete reaction between methane and oxygen is obtained. According to the result of control example 15 and control example 17, although the oxygen content of the product coal mine methane is lower than 1000 ppm, a relatively high hydrogen and carbon monoxide concentration of the product coal mine methane is observed because of the increased side reactions such as the decomposition carbon deposition of methane and steam reforming of methane resulting from a relatively high operation temperature of the deoxygenation reactor, and thus added the difficulty of the subsequent liquefaction of the deoxygenated coal mine methane. Therefore, maintaining an operation temperature of the deoxygenation reactor below 650° C. by adjusting the recycle rate of the product coal mine methane is another critical issue for the catalytic deoxygenation process of the present invention.

TABLE 6
Result under different operation conditions according to example 15 to example 17

| Example | 10 | 11 | 12 | 13 | 14 | 15 | 16 | 17 |
|---|---|---|---|---|---|---|---|---|
| Raw oxygen-contained | | | | | | | | |
| coal mine methane: | | | | | | | | |
| Flow, Nm³/hr | 30 | 30 | 30 | 40 | 30 | 30 | 30 | 30 |
| Pressure (gauge pressure) | 0.00 | 0.00 | 0.00 | 0.00 | 0.02 | 0.00 | 0.00 | 0.00 |
| Temperature, ° C. | 25 | 25 | 25 | 25 | 25 | 25 | 25 | 25 |
| Dry basis composition, | 40.0 | 44.0 | 40.0 | 40.0 | 40.0 | 40.0 | 44.0 | 40.0 |
| vol % CH4 | | | | | | | | |
| vol % N2 | 48.0 | 50.0 | 48.0 | 48.0 | 48.0 | 48.0 | 50.0 | 48.0 |
| vol % O2 | 12.0 | 6.0 | 12.0 | 12.0 | 12.0 | 12.0 | 6.0 | 12.0 |
| Gas at the inlet of the | | | | | | | | |
| reactor: | | | | | | | | |
| Flow, Nm³/hr | 90 | 60 | 120 | 160 | 120 | 60 | 60 | 210 |
| Pressure(gauge pressure) | 0.03 | 0.03 | 0.03 | 0.03 | 0.05 | 0.03 | 0.03 | 0.03 |
| Temperature, ° C. | 336 | 285 | 380 | 385 | 385 | 300 | 325 | 574 |
| Dry basis composition, | 35.72 | 42.29 | 35.22 | 35.17 | 35.19 | 34.49 | 42.17 | 32.02 |
| vol % CH4 | | | | | | | | |
| vol % N2 | 48.00 | 50.00 | 48.00 | 48.00 | 48.00 | 48.00 | 50.00 | 48.00 |
| vol % O2 | 4.03 | 3.05 | 3.07 | 3.07 | 3.05 | 6.01 | 3.05 | 1.76 |
| vol % H2 | 0.09 | 0.04 | 0.09 | 0.08 | 0.06 | 0.66 | 0.11 | 1.09 |
| vol % CO | 0.07 | 0.07 | 0.07 | 0.09 | 0.11 | 0.78 | 0.08 | 1.30 |
| vol % CO2 | 4.08 | 1.56 | 4.56 | 4.60 | 4.59 | 3.57 | 1.61 | 5.55 |
| vol % H2O | 8.00 | 3.00 | 9.00 | 9.00 | 9.00 | 6.50 | 3.00 | 10.29 |
| Gas at the outlet of the | | | | | | | | |
| reactor: | | | | | | | | |
| Flow, Nm³/hr | 90 | 60 | 120 | 160 | 120 | 60 | 60 | 210 |
| Pressure(gauge pressure) | 0.01 | 0.01 | 0.01 | 0.01 | 0.02 | 0.01 | 0.01 | 0.01 |
| Temperature, ° C. | 640 | 530 | 603 | 640 | 600 | 750 | 575 | 703 |
| Dry basis composition, | 33.58 | 40.57 | 33.62 | 33.56 | 33.59 | 28.98 | 40.33 | 30.69 |
| vol % CH4 | | | | | | | | |
| vol % N2 | 48.00 | 50.00 | 48.00 | 48.00 | 48.00 | 48.00 | 50.00 | 48.00 |
| vol % O2 | 0.05 | 0.09 | 0.09 | 0.09 | 0.07 | 0.02 | 0.09 | 0.05 |
| vol % H2 | 0.14 | 0.08 | 0.12 | 0.10 | 0.08 | 1.32 | 0.21 | 1.27 |
| vol % CO | 0.11 | 0.14 | 0.09 | 0.12 | 0.14 | 1.55 | 0.16 | 1.52 |
| vol % CO2 | 6.12 | 3.12 | 6.08 | 6.13 | 6.12 | 7.13 | 3.21 | 6.47 |
| vol % H2O | 12.00 | 6.00 | 12.00 | 12.00 | 12.00 | 13.00 | 6.00 | 12.00 |
| Recycle gas: | | | | | | | | |
| Flow, Nm³/hr | 60 | 30 | 90 | 120 | 90 | 30 | 30 | 180 |
| Pressure(gauge pressure) | 0.03 | 0.03 | 0.03 | 0.03 | 0.03 | 0.03 | 0.03 | 0.03 |
| Temperature, ° C. | 444 | 481 | 474 | 485 | 480 | 573 | 570 | 689 |
| Circulation rate R | 2 | 1 | 3 | 3 | 3 | 1 | 1 | 6 |
| Dry basis composition, | 33.58 | 40.57 | 33.62 | 33.56 | 33.59 | 28.98 | 40.33 | 30.69 |
| vol % CH4 | | | | | | | | |
| vol % N2 | 48.00 | 50.00 | 48.00 | 48.00 | 48.00 | 48.00 | 50.00 | 48.00 |
| vol % O2 | 0.05 | 0.09 | 0.09 | 0.09 | 0.07 | 0.02 | 0.09 | 0.05 |
| vol % H2 | 0.14 | 0.08 | 0.12 | 0.10 | 0.08 | 1.32 | 0.21 | 1.27 |
| vol % CO | 0.11 | 0.14 | 0.09 | 0.12 | 0.14 | 1.55 | 0.16 | 1.52 |
| vol % CO2 | 6.12 | 3.12 | 6.08 | 6.13 | 6.12 | 7.13 | 3.21 | 6.47 |
| vol % H2O | 12.00 | 6.00 | 12.00 | 12.00 | 12.00 | 13.00 | 6.00 | 12.00 |
| Product coal mine | | | | | | | | |
| methane: | | | | | | | | |
| Flow, Nm³/hr | 26 | 26 | 26 | 35 | 26 | 26 | 26 | 26 |
| Pressure(gauge pressure) | 0.00 | 0.00 | 0.00 | 0.00 | 0.00 | 0.00 | 0.00 | 0.00 |
| Temperature, ° C. | 25 | 25 | 25 | 25 | 25 | 25 | 25 | 25 |
| Dry basis composition, | 38.16 | 43.16 | 38.20 | 38.14 | 38.17 | 33.31 | 42.90 | 34.88 |
| vol % CH4 | | | | | | | | |
| vol % N2 | 54.55 | 53.19 | 54.55 | 54.55 | 54.55 | 55.17 | 53.19 | 54.55 |
| vol % O2 | 0.06 | 0.10 | 0.10 | 0.10 | 0.08 | 0.02 | 0.01 | 0.06 |
| vol % H2 | 0.16 | 0.09 | 0.14 | 0.11 | 0.09 | 1.52 | 0.22 | 1.44 |
| vol % CO | 0.13 | 0.15 | 0.10 | 0.14 | 0.16 | 1.78 | 0.17 | 1.73 |
| vol % CO2 | 6.95 | 3.32 | 6.91 | 6.97 | 6.95 | 8.20 | 3.41 | 7.35 |

### Example 18-Example 21

Example 18 to example 21 have studied the ignition performance of catalytic deoxygenation under different composition of ignition gas, the catalyst is a honeycomb ceramic monolithic catalyst wherein the weight percentage composition thereof the is 0.2% Pd/15% CeO2-5% La203/79.8% cordierite, and GHSV of the ignition gas is hr⁻¹. From the experiment result as shown in Table 7, for oxygen-contained raw coal mine methane (example 21), the catalytic deoxygenation process could not get started unless the raw gas is preheated to above 280° C. under the same experimental condition of the present invention, additional heating apparatus for preheating the raw gas before getting into the deoxygenation reactor would definitely increase the complexity of the deoxygenation process. Therefore, the raw coal mine methane is firstly added with an amount of hydrogen wherein hydrogen and oxygen react onto the deoxygenation catalyst to generate heat to preheat the catalyst bed so that the temperature of the catalyst bed reached the ignition temperature of the methane so that the whole deoxygenation system successfully launched.

TABLE 7
Ignition performance of the catalytic deoxygenation system under
different composition of ignition gas

| | | Ignition temperature/ |
|---|---|---|
| | | preheated temperature, |
| Example | Composition of ignition gas | ° C. |
| 18 | 37% CH4 + 47% N2 + 6% O2 + | 25 |
| | 10% H2 | |
| 19 | 50% CH4 + 42% N2 + 2% O2 + | 50 |
| | 6% H2 | |
| 20 | 37% CH4 + 55% N2 + 6% O2 + | 78 |
| | 2% H2 | |
| 21 | 40% CH4 + 48% N2 + 12% O2 | 280 |

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A catalyst for deoxygenation of coal mine methane, comprising:
a first composition which consists of one or more platinum group noble metals constituting an active constituent thereof, wherein said first composition has a percentage weight of 0.01-5% noble metals based on the total weight of said catalyst, wherein said noble metals has a percentage weight of 50-100% Pd based on the total weight of said noble metals;
a second composition consisting of one or more alkaline metals or alkaline earth metals, and a CeO₂-based composite oxide, wherein a percentage weight of said alkaline metals or alkaline earth metals is 1-10% based on the total weight of said catalyst, wherein a percentage weight of said CeO2-based composite oxide is 1-70% based on the total weight of said catalyst, wherein a percentage weight of CeO2 is 30-100% based on the total weight of said CeO2-based composite oxide; and
a carrier consisting of one or more selected from the group consisting of cordierite ceramic honeycomb, mullite ceramic honeycomb, Al2O3 ceramic honeycomb, metallic honeycomb and foam metal carrier;
wherein said first composition and said second composition are loaded onto said carrier through coating.

2. The catalyst, as recited in claim 1, wherein said platinum group noble metals consist of Pd, Pt, Ru, Rh and Ir.

3. The catalyst, as recited in claim 1, wherein said alkaline metals or alkaline earth metals consist of Na2O, K2O, MgO, CaO, SrO and BaO.

4. The catalyst, as recited in claim 1, wherein said CeO2-based composite oxide consists of CeO2 and at least one compound selected from lanthanides rare earth metals, transition metals and γ-Al2O3 oxide complexes, wherein said lanthanides rare earth metals consists of Pr, Nd, Sm, Eu, Gd, wherein said transition metals consists of Y, Zr, La.

5. The catalyst, as recited in claim 2, wherein first composition is Pd, Pd—Rh, Pd—Pt or Pd—Rh—Pt.

6. The catalyst, as recited in claim 3, wherein at least one of said alkaline metals or alkaline earth metals is MgO, K2Oor CaO.

7. The catalyst, as recited in claim 4, wherein said CeO2-based composite oxide is one or more of the group consisting of Ce—Zr, Ce—Sm, Ce—Zr—Al and Ce—Zr—Y.

8. The catalyst, as recited in claim 1, wherein said percentage weight of said noble metals based on the total weight of said catalyst is 0.1-1%.

9. The catalyst, as recited in claim 1, wherein said percentage weight of Pd based on the total weight of said noble metals is 70-90%.

10. The catalyst, as recited in claim 1, wherein said percentage weight of said alkaline metals or alkaline earth metals is 2-5% based on the total weight of said catalyst.

11. The catalyst, as recited in claim 1, wherein said percentage weight of said CeO2-based composite oxide is 5-30% based on the total weight of said catalyst.

12. The catalyst, as recited in claim 1, wherein said percentage weight of CeO2 based on the total weight of said CeO2-based composite oxide is 40-75%.

13. The catalyst, as recited in claim 1, is prepared by a preparation process comprising the steps of:
(1) preparing and loading said CeO2-based composite oxide onto said carrier which has a systematic structural construction to form a first catalyst precursor A through drying and calcination;
(2) loading said alkaline metals or alkaline earth metals onto said first catalyst precursor A from step (1) to form a second catalyst precursor B through drying and calcination;
(3) loading said platinum group noble metals onto said second catalyst precursor B from step (2) to form a third catalyst precursor C in oxidized form through drying and calcination; and
(4) converting said third catalyst precursor C in oxidized form to form said catalyst in final form D through a reduction process.

14. The catalyst, as recited in claim 13, wherein said CeO2-based composite oxide is formed by two or more components integrated in a microcrystalline mixture having a granular diameter smaller than 500 nm.

15. The catalyst, as recited in claim 13, wherein said CeO2-based composite oxide is prepared by co-precipitation, homogeneous precipitation, reverse micro-emulsion, hydrothermal synthesis or deposition/precipitation.

16. The catalyst, as recited in claim 13, wherein in step (1) comprises the steps of:
(1a) providing and putting said CeO2-based composite oxide in powder form into de-ionized water;
(1b) obtaining said CeO2-based composite oxide in slurry form which has a percentage weight between 20 and 40% through high energy ball milling;
(1c) adjusting a pH value of said CeO2-based composite oxide in slurry form to 3-4 by adding nitric acid;
(1d) coating said CeO2-based composite oxide in slurry form to said carrier to obtain said catalyst precursor A by drying and calcination;
(1e) selectively repeating the step (1d) for adjusting a predetermine weight of said CeO2 which is loaded onto said carrier.

17. The catalyst, as recited in claim 13, wherein in step (2) comprises the steps of:
(2a) providing an alkaline metals or alkaline earth metals precursor in solution form which is water soluble and loading to said first catalyst precursor A through impregnation;
(2b) drying and calcination to obtain said second catalyst precursor B;
(2c) selectively repeating the above steps (2a) and (2b) for adjusting a predetermine weight of said alkaline metals or alkaline earth metals which is loaded onto said carrier.

18. The catalyst, as recited in claim 13, wherein in step (3) comprises the steps of:
(3a) providing a platinum group noble metals precursor in solution or in solution mixture form which is water soluble and loading to said second catalyst precursor B through impregnation;
(3b) drying and calcination to obtain said third catalyst precursor C;
(3c) selectively repeating the above steps (3a) and (3b) for adjusting a predetermine weight of said platinum group noble metals which is loaded onto said carrier.

19. The catalyst, as recited in claim 13, wherein in step (4), said reduction process comprises the step of: allowing reduction reaction of said third catalyst precursor C in oxidized form with 10% H₂-90% N₂ with a temperature of 450-550° C. for 2-4 hours.

20. The catalyst, as recited in claim 1, further comprising an application process of catalytic deoxygenation of oxygen-containing coal mine methane.

21. The catalyst, as recited in claim 1, further comprising an application process of catalytic deoxygenation of oxygen-containing coal mine methane with systematic and low-temperature ignition; specific operation procedure and operation parameters, which comprises the steps of:
introducing a small amount of preheated hydrogen gas at 25-50° C. into a preprocessed coal mine methane which contains oxygen and then reacting with said catalyst for burning and releasing energy to preheating said catalyst such that a bed temperature of said catalyst bed is increased to reach an ignition temperature of methane for catalytic combustion to produce a processed coal mine methane;
when the catalytic combustion reaches a stable status, diverting said processed coal mine methane to mix with said preprocessed coal mine methane to form a mixture gas which is then input into a heat-resistance fix-bed reactor through a reactor inlet, wherein said reactor comprises said catalyst which contains said noble metals,
allowing reaction in which methane in said mixture gas reacts with oxygen through catalysis to produce carbon dioxide and water and to obtain a first product gas,
removing water content of said first product gas by heat exchange and cooling to obtain a final product gas,
selectively adjusting a concentration of oxygen content in said mixture gas through circulating a portion of said final product gas based on a preset recycle ratio to said reactor inlet of said reactor, wherein
(21-1) said preprocess coal mine methane has an oxygen content of 1%-15% by volume,
(21-2) said final product gas has an oxygen content of less than 0.2% by volume,
(21-3) said reactor has an operation pressure of 0-10 MPa and a space velocity of 1,000-80,000 hr⁻¹, and said catalyst bed has an inlet bed temperature of 250-450° C. and an outlet bed temperature of 450-650° C.,
(21-4) said water content is removed through a two-level heat exchange and cooling process such that the temperature of said final gas product is lowered to 30-50° C., and
(21-5) a flow ratio of said final product gas circulating to said reactor to said preprocessed coal mine methane is 0:1 to 6:1 by volume.

22. The catalyst, as recited in claim 21, wherein in said application process of catalytic deoxygenation of oxygen-containing coal mine methane, said oxygen content of said final product gas is less than 0.2% by volume.

23. The catalyst, as recited in claim 21, wherein in said application process of catalytic deoxygenation of oxygen-containing coal mine methane, said operation pressure of said reactor is 0.01-0.03 MPa and said space velocity is 30,000-50,000 hr⁻¹, and said inlet bed temperature is 285-325° C. and said outlet bed temperature is 550-650° C.

24. The catalyst, as recited in claim 21, wherein in said application process of catalytic deoxygenation of oxygen-containing coal mine methane, said heat exchange and cooling is carried out through at least one high temperature heat exchanger or a heat boiler and at least one low temperature heat exchanger.

25. The catalyst, as recited in claim 21, wherein in said application process of catalytic deoxygenation of oxygen-containing coal mine methane, said flow ratio of said final product gas circulating to said reactor to said preprocessed coal mine methane is 0:1 to 4:1 by volume.

26. The catalyst, as recited in claim 21, wherein in said application process of catalytic deoxygenation of oxygen-containing coal mine methane, said low-temperature ignition is achieved by introducing said small amount of said hydrogen gas into said preprocessed coal mine methane which contains oxygen such that said oxygen in said preprocessed coal mine methane and said hydrogen gas are burnt on said catalyst to release energy and preheat said catalyst until said bed temperature of said catalyst bed is increased to reach 250-450° C., which is the ignition temperature of methane for catalytic combustion.

27. The catalyst, as recited in claim 21, wherein in said application process of catalytic deoxygenation of oxygen-containing coal mine methane, said low-temperature ignition is achieved by introducing said small amount of said hydrogen gas into said preprocessed coal mine methane which contains oxygen and is preheated through a heater such that said oxygen in said preprocessed coal mine methane and said hydrogen gas are burnt on said catalyst to release energy and preheat said catalyst until said bed temperature of said catalyst bed is increased to reach 250-450° C., which is the ignition temperature of methane for catalytic combustion.

28. The catalyst, as recited in claim 21, wherein in said application process of catalytic deoxygenation of oxygen-containing coal mine methane, wherein said final product gas which is circulated back to said reactor is first cooled through a heat exchanger for dehydration and is then preheated by high temperature reaction gas at said reactor outlet before mixing with said preprocessed coal mine methane at room temperature.

29. The catalyst, as recited in claim 21, wherein in said application process of catalytic deoxygenation of oxygen-containing coal mine methane, wherein said final product gas which is circulated back to said reactor is obtained from said reactor outlet of said reactor.

30. The catalyst, as recited in claim 24, wherein in said application process of catalytic deoxygenation of oxygen-containing coal mine methane, said high temperature heat exchanger or a heat boiler lowers the temperature of exhaust gas at said reactor outlet to 150-500° C.

31. The catalyst, as recited in claim 24, wherein in said application process of catalytic deoxygenation of oxygen-containing coal mine methane, said low temperature heat exchanger lowers the temperature of exhaust gas of said high temperature heat exchanger or a heat boiler to 30-50° C.

32. The catalyst, as recited in claim 26 or 27, wherein in said application process of catalytic deoxygenation of oxygen-containing coal mine methane, a volume flow of said hydrogen gas to preprocessed coal mine methane is 4-10%.

33. The catalyst, as recited in claim 27, wherein in said application process of catalytic deoxygenation of oxygen-containing coal mine methane, said preprocessed coal mine methane is preheated to 30-50° C.
